(19) United States
(12) Patent Application Publication
(10) Pub. No.: US 2026/0205053 A1
(43) Pub. Date: Jul. 16, 2026

(54) WIND DEFLECTOR FOR SOLAR ARRAYS

(71) Applicant: 1st Avenue Nova, LLC, Los Angeles, CA (US)

(72) Inventor: Thomas BUTTGENBACH, Santa Monica, CA (US)

(73) Assignee: 1st Avenue Nova, LLC, Los Angeles, CA (US)

(21) Appl. No.: 19/450,338

(22) Filed: Jan. 15, 2026

Related U.S. Application Data
(60) Provisional application No. 63/745,451, filed on Jan. 15, 2025.

(51) Int. Cl. H02S 30/00; H02S 20/23

(52) U.S. Cl. CPC H02S 30/00; H02S 20/23

(57) ABSTRACT

An apparatus includes a wind deflector for a solar tent array. The wind deflector includes at least a first solar module and a second solar module that are each positioned to form an apex of the solar tent array. The wind deflector includes at least one of a gable end portion configured to reduce airflow through a first area at least partially defined by the apex or a side portion configured to reduce airflow through a second area at least partially defined by a lower edge portion of the solar tent array. The gable end portion is disposed, during use, between the apex and a surface beneath the lower edge portion. The side portion of the wind deflector is disposed, during use, between the lower edge portion and the surface. The apparatus includes a substantially rigid connector configured to mechanically couple the wind deflector to the solar tent array.

### CROSS REFERENCE TO RELATED APPLICATION

This application claims priority to U.S. Provisional Patent Application No. 63/745,451, filed Jan. 15, 2025 and titled “WINDSHIELD STRUCTURE FOR SOLAR ARRAYS,” the contents of which are incorporated by reference herein in their entirety.

### TECHNICAL FIELD

The present disclosure relates to a wind deflector for solar arrays, to a method of reducing aerodynamic lifting forces on solar modules, to transportable solar microutility system, and to systems and methods for microgrid metering and energy allocation.

### BACKGROUND

Some known solar panel systems include wind deflectors (or “windshields”) to reduce aerodynamic lifting forces that may be exerted on the solar panels during use. Some known solar wind deflectors for solar cells and/or solar modules are often implemented as vertical walls, angled (straight, planar) walls, scoops that are concave upwards (i.e., shallow down low and farther from the solar module, becoming steep up high and closer to the solar module), or scoops that are concave downwards (i.e., steep down low and farther from the solar module, becoming shallower up high and closer to the solar module). Some known solar wind deflectors have also been implemented as “standoff” wind deflectors, i.e., leaving a gap between the wind deflector and the edge of the solar module and/or the edge of the solar array, to allow cooling air to flow under the solar module while excluding/blocking high-speed airflow under the solar module due to wind (and/or due to airflows that arise because the solar module is mounted on top of a vehicle). In some cases, some known wind deflectors can be attached to a supporting structure that acts as a support structure and/or racking for the solar module. Such known solar wind deflectors, however, are often not suitable for use with solar panel systems deployed on uneven surfaces (e.g., ungraded land, ground, naturally graded surface of the land, etc.) and/or for large arrays of (e.g., high-density) solar panel systems. Additionally, such known solar wind deflectors typically do not provide functionality of a planar support and/or racking for the solar module, relying on for example earth ground anchors for support. Consequently, a need exists for systems and methods of reducing aerodynamic lifting forces on solar panels.

### SUMMARY

In some embodiments, an apparatus includes a wind deflector for a solar tent array. The wind deflector includes at least a first solar module and a second solar module. The first solar module and the second solar module are each positioned to form an apex of the solar tent array. The wind deflector includes at least one of: (i) a gable end portion configured to reduce airflow through a first area or (ii) a side portion configured to reduce airflow through a second area. The first area is defined at least in part by the apex of the solar tent array. The gable end portion of the wind deflector is configured, during use, to be disposed between the apex of the solar tent array and a surface beneath a lower edge portion of the solar tent array. The second area is defined in part by the lower edge portion of the solar tent array. The side portion of the wind deflector is configured, during use, to be disposed between the lower edge portion of the solar tent array and the surface beneath the lower edge portion of the solar tent array. The apparatus also includes a substantially rigid connector configured to mechanically couple the wind deflector to the solar tent array.

In some embodiments, an apparatus includes a wind deflector. The wind deflector includes a gable end portion. The gable end portion has a first edge, a second edge, and a base. The base is configured, during use, to contact at least one of (i) a lower edge portion of a frame of a first solar module or (ii) a lower edge portion of a frame of a second solar module. The base is also configured, during use, to define an air gap to permit a specified amount of airflow therethrough. The apparatus also includes a first coupler configured to rigidly connect the first edge of the gable end portion to the frame of the first solar module. The apparatus also includes a second coupler configured to rigidly connect the second edge of the gable end portion to the frame of the second solar module. The first solar module and the second solar module define a solar tent array. The wind deflector is configured, during use, to reduce aerodynamic lifting forces on the solar tent array.

In some embodiments, a system includes a solar tent array. The solar tent array includes at least a first solar module and a second solar module. The system also includes a wind deflector. The wind deflector includes a gable end portion configured, during use, to set a nonzero angle between the first solar module and the second solar module to a predefined value to form an apex of the solar tent array. The gable end portion is also configured, during use, to reduce airflow between a first portion of the solar tent array and a second portion of the solar tent array. The first portion is opposite to the second portion. The gable end portion of the wind deflector is at least partially disposed between the apex of the solar tent array and a first lower edge portion of the solar tent array when the gable end portion is in use. The wind deflector also includes a side portion configured, during use, to reduce airflow between the first lower edge portion of the solar tent array and a second lower edge portion of the solar tent array. The first lower edge portion is opposite to the second lower edge portion.

### BRIEF DESCRIPTION OF THE DRAWINGS

FIG. 1 depicts a perspective view of an example solar tent array, according to an embodiment.

FIG. 2 depicts a perspective view of a wind deflector system including a gable end wind deflector for a solar tent array, according to an embodiment.

FIG. 3 depicts a perspective view of a wind deflector system including a gable end portion and a side portion for a solar tent array, according to an embodiment.

FIG. 4 depicts a perspective view of a wind deflector system including upturned portions for a solar tent array, according to an embodiment.

FIG. 5 depicts a cross-sectional view of a wind deflector system including side wind deflectors defining vertical gaps, according to some embodiments.

FIG. 6A depicts a detailed partial cross-sectional view of a wind deflector system including a vertical wall side wind deflector defining a lateral gap, according to an embodiment.

FIG. 6B depicts a detailed partial cross-sectional view of a wind deflector system including a scoop side wind deflector defining a lateral air gap, according to an embodiment.

FIG. 7 depicts a detailed, cutaway perspective view of a wind deflector system including a support structure for mechanically supporting a solar module, according to an embodiment.

FIG. 8 depicts a detailed, cutaway perspective view of a wind deflector system including a standoff wind deflector providing functionality of a planar support for a solar module, according to an embodiment.

FIG. 9 depicts a cross-sectional view of a wind deflector system including a baffle for a solar tent array, according to an embodiment.

FIG. 10 depicts a perspective view of a wind deflector system including raised edges disposed above a solar tent array, according to an embodiment.

FIG. 11A depicts a partial cross-section view of a wind deflector system including a type of ledge for mechanically supporting a solar module, according to an embodiment.

FIG. 11B depicts a partial cross-section view of a wind deflector system including another type of ledge for mechanically supporting a solar module, according to another embodiment.

FIG. 12 is an image of an example transportable solar microutility system, according to an embodiment.

FIG. 13 is an image of an example solar panel rack of a transportable solar microutility system, according to an embodiment.

FIG. 14 is an image of an example system for storing solar panel racks within a shipping container, according to an embodiment.

FIG. 15 is an image of example electrical equipment configured in stored positions within a shipping container, according to an embodiment.

FIG. 16 is a diagram of an example microgrid system for microgrid metering and energy allocation, according to an embodiment.

FIG. 17 is a graph depicting an example energy production forecast and allocation with prioritization, according to an embodiment.

FIG. 18 depicts a perspective view of a configuration for rails within a shipping container, according to an embodiment.

FIG. 19 depicts a perspective view of a solar panel rack of a solar array, according to an embodiment.

FIG. 20 depicts a perspective view of an example system for storing solar panel racks within a shipping container, according to an embodiment.

### DETAILED DESCRIPTION

One or more embodiments of the present disclosure include a method of reducing aerodynamic lifting forces on a ground-mounted (or low-mounted) solar array in a “tent” or “inverted V” configuration. The present disclosure also describes how such methods can be configured to incorporate a “racking” function for the solar array. Solar arrays described herein can be part of, or adapted for inclusion with, a transportable solar microutility system.

One or more embodiments of the present disclosure include the use of a substantially triangular (or triangle-like, or other substantially poly gonal shaped) wind deflector across the “gable end” of each pair of solar modules configured in a “tent” arrangement. As used herein, a pair of solar modules configured in a “tent” arrangement is also referred to as a solar tent array.

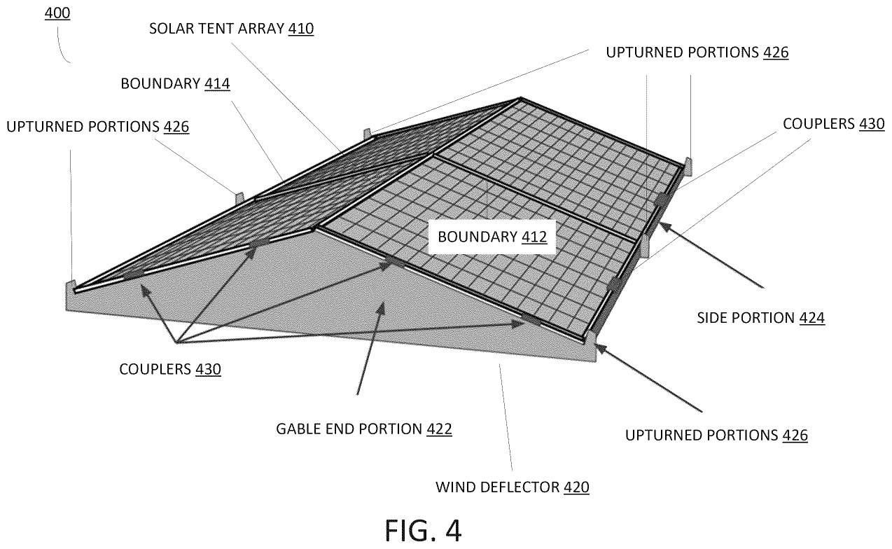

One or more embodiments of the present disclosure include using the substantially triangular (or other substantially polygonal shaped) wind deflector optionally as a planar support supporting the solar modules that are in the tent arrangement. One or more embodiments of the present disclosure include using the substantially triangular (or other substantially polygonal shaped) wind deflector as a load-distributing element supporting the solar modules in the tent arrangement, helping to ensure that the solar modules do not sink into the ground (or another malleable surface) when the ground is soft (e.g., soft due to weather events such as rain, soft due to ground composition, etc.) as solar modules would otherwise tend to do if supported by, for example, resting the edges of the solar modules on the ground. Stated similarly, the wind deflector can in some embodiments be configured during use to distribute the weight of a solar tent array across the ground to reduce deformation of the ground by the solar tent array. One or more embodiments of the present disclosure include use of a baffle disposed between a first side of the solar tent array and a second side of the solar tent array opposite to the first side (e.g., disposed under the ridge line (or apex) of the solar tent array), to reduce aerodynamic forces resulting from wind blowing across (rather than along the length of) the solar tent array. One or more embodiments of the present disclosure include use of the baffle as a planar support supporting the solar modules along the ridge line (or apex) of the solar tent array. One or more embodiments of the present disclosure include use of wind deflectors with raised edge portions that can be disposed above the upper surface(s) (e.g., the active surface(s)) of the solar modules, to cause an aerodynamic spoiler effect and diminish lifting forces on the solar modules caused by wind flowing over them. One or more embodiments of the present disclosure include an upturned feature (also referred to herein as a “mustache stop” feature as described with respect to FIG. 4) for supporting the solar modules during, for example, construction (or deployment).

One or more embodiments of the present disclosure involve the use of high-density solar arrays, i.e., solar arrays with a high ground coverage ratio. Such high density can be achieved by positioning the solar modules on, for example, low-profile racking systems or directly on the ground, so that the solar modules are immediately adjacent to each other with no (or with minimal) gaps between the solar modules. Such positioning contrasts with known tracking systems and/or with known south-facing fixed-tilt racking systems, which have significant gaps between the rows of solar modules.

In some implementations, a “tent” or “inverted V” configuration is used, in which the solar modules are positioned so that they are tilted, alternating between an east-tilted and west-tilted arrangement, so that when viewed from the north or south end the array appears like rows of ridge tents or flat, inverted V shapes. In some implementations, the solar modules may alternate between north-tilted and south-tilted, with the same type of “tent” or “inverted V” configuration. A solar tent array can be characterized by, for example, an angular position of a first solar module from the pair of solar modules relative to the second solar module from the pair of solar modules, the formation of a nonzero (e.g., greater than zero degrees and less than 180 degrees) angle between the first solar module from the pair of solar modules and the second solar module from the pair of solar modules, and/or the formation of an apex between (an edge of) the first solar module from the pair of solar modules and (an edge of) the second solar module from the pair of solar modules and that represents a highest point (or set of points) of the solar tent array above a surface.

A first concern with some known solar arrays is that strong winds can lift solar modules from their place and damage the array as well as create a risk that the displaced (e.g., flying) solar modules can cause impact damage to other property or injure individuals downwind.

To address this concern, solar modules can be anchored in place, for example either to a racking structure that is itself anchored in place, or directly to the ground. The engineered strength of the ground anchors should be matched to the expected aerodynamic lifting forces that can be generated by the solar modules in a strong wind.

One or more embodiments set forth herein include a method of reducing aerodynamic lifting forces on solar modules, thereby improving safety and reducing the reliance on the engineered strength of the ground anchors. This can be accomplished, in accordance with some implementations, by installing a “windshield” (also referred to herein as an “air dam” or a “wind deflector”) at the ends of each “tent” row, which limits or prevents wind from flowing freely under the array, limiting the aerodynamic lifting forces that can be generated.

A second consideration with many solar arrays is that the solar modules are fixed in their desired position using, for example, a “racking” system—i.e., a support that underlies the solar modules and holds them in position. A racking system can be used to safely secure solar panels (or solar modules) to target surfaces such as for example roofs, building facades, or the ground. In some embodiments, a racking system can include mounts (or feet) configured to be disposed on (or coupled to) a target surface, rails (or tracks) configured to provide a surface for the solar module(s), and/or couplers configured to couple the solar module(s) to the rails. In one or more embodiments set forth herein, the disclosed wind deflector (or air dam) can also serve as (i.e., provide functionality of) a racking system for solar modules. There are at least two aspects to such embodiments: first, the wind deflector (or air dam) can support the weight of the solar modules, holding them in position at the desired tilt angles, and can distribute the weight of the solar modules across the ground, improving stability of the solar array such that the solar array does not sink into the ground (which could be an issue where the ground is soft or otherwise malleable, either permanently or occasionally as a result of weather events such as rainfall). The second aspect depends on the wind deflector (or air dam) having a sufficiently large surface area when disposed on the ground, and on the wind deflector (or air dam) being relatively light.

In some embodiments, a wind deflector can be used to set an angle between the solar modules and/or solar module rows. In some such implementations, a tension load is imposed (or imparted) across the wind deflector, which may then be constructed in a manner that is strong enough to support that load (e.g., for the lifetime of the system).

A variety of additional benefits are set forth below, which can be obtained from the use of wind deflector (or air dam) configurations and/or baffle configurations set forth herein, in accordance with some embodiments.

One or more embodiments of the present disclosure relate to a transportable solar microutility system. The word “microutility,” in this context, can refer to a small-scale, localized, self-contained electrical grid capable of serving (e.g., supplying power to) multiple users and/or servicing multiple users (e.g., customers) within a limited area such as for example a campus, neighborhood or building, often operating independently or seamlessly in connection with a larger grid. As a solar microutility, the default energy source for the microutility system itself is solar energy. Other energy sources, however, can be used in addition or as an alternative to solar. For example, the system can include one or more fossil fueled generators connected to it, and/or can be configured to draw power from a larger electrical grid.

In one or more embodiments, a transportable solar microutility system is relatively easily moved (or transported) for rapid deployment to a new (or active) site and/or for rapid removal from an old (or inactive) site. In some such implementations, many (and in some instances, all) the elements of a solar power plant including for example a solar array(s), battery energy storage system(s) (BESS), energy management system (EMS), load management system, wiring and communications can be transported in a single shipping container (e.g., a shipping container that is 40 feet in length).

In addition to generating and storing solar energy, one or more implementations of the transportable solar microutility system can be configured to manage delivery of that energy to connected users. This can include, for example, managing connection of customers and/or disconnection of customers and/or managing billing. In an “islanded all-renewable” system (i.e., in which there is no grid connection, and no fossil generation), such management activities can also include handling situations where unusually large user loads impede the system's ability to deliver expected amounts of energy to other users, and/or handling situations where the ability to deliver expected amounts of energy to customers is impeded by undesirable weather (rather than unusually large user loads). In an “islanded” system (i.e., no grid connection), such management activities can include for example determining how to combine load curtailment (whether enforced or voluntary) with fossil generation to ensure that commitments to deliver energy will be met. In an on-grid system, such management activities can include for example determining how to draw energy from, and potentially deliver energy to, a connected electrical grid.

In some embodiments, a transportable solar microutility system includes software to perform (e.g., software to cause a processor to execute) one or more instructions. Such instructions can cause a processor to manage energy flows from the solar array(s) to user load(s) and/or to a BESS, to manage energy flows from a BESS to user load(s) and/or to a connected utility grid, and/or to manage energy flows, where relevant, from the connected utility grid to a BESS and/or to customer load(s). Such instructions can, instead or in addition, cause a processor to manage energy allocations and related user communications. For example, managing energy allocations and related user communications can include assigning energy allowances to users based on an energy production forecast (or prediction, estimation, etc.), assigning energy allowances to users based on an energy state of the BESS, and/or assigning energy allowances to users based on user characteristics and/or user preferences. Instead, or in addition, managing energy allocations and related user communications can include forecasting (or predicting, estimating, etc.) whether the energy allowances will be satisfied and, if not, identifying steps that can be taken to address the projected shortfall, e.g., to notify users that they need to limit their consumption, to disconnect noncompliant users, to start a fossil fuel generator, and/or to draw energy from the grid, either to serve user loads directly and/or to charge the BESS (or both). Such instructions can, instead or in addition, cause a processor to cause energy connection to users and/or to cause energy disconnection to users, e.g., to cause energy connection to new users and/or to cause energy reconnection to users when specified (or desired, needed, etc.), to cause energy disconnection to departing users, and/or to cause energy disconnection to non-compliant (e.g., non-paying, etc.) users. Such instructions can, instead or in addition, cause a processor to support management of the microutility (e.g., including setup of the microutility and/or takedown of the microutility, troubleshooting the microutility, user account management, energy allocation(s) determination, etc.).

In some implementations, software included as part of a transportable solar microutility system, in accordance with the present disclosure, is configured to cause a processor to one or more of: (a) record energy limits for load(s), (b) forecast electrical energy production by the system, (c) allocate electrical energy among the loads, (d) direct the delivery of energy and/or distribution of energy according to the allocation, (e) determine whether (or that) the available energy will be sufficient, and in response take actions to address that condition (which might include, for example, disconnecting one or more of the lowest-priority loads, or notifying (e.g., causing transmission of a signal to) the associated user(s) that they should reduce their consumption).

Additional details regarding systems and methods for microgrid metering and energy allocation, compatible with embodiments set forth herein, can be found, by way of example, in U.S. Pat. Nos. 11,431,169, 11,489,337, and U.S. Patent Application Publication No. 2023/0187933, the entire contents of each of which are incorporated by reference herein for all purposes.

In one or more embodiments, a transportable solar microutility system can be configured to (e.g., via software and/or hardware) manage electrical energy by (for example) storing priorities for one or more user loads, forecasting an amount of available energy, allocating energy amounts to the loads in priority order, and directing delivery of the electrical energy and/or distribution of the electrical energy accordingly. Optionally, in some implementations, such systems can further be configured to provide notifications (e.g., cause transmission of signals) to users through (for example) handheld devices (e.g., mobile compute devices).

One example type of solar module configuration, in accordance with some embodiments, is the “tent” array or “inverted V,” in which the solar modules are positioned in rows with alternating tilt, so that the array appears like rows of ridge tents or flat, inverted V shapes.

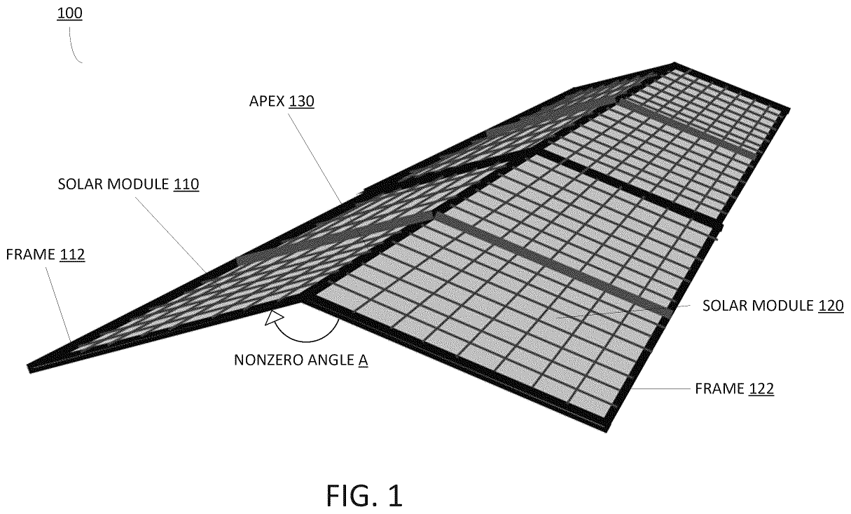

FIG. 1 depicts a perspective view of an example solar tent array 100, according to an embodiment. Solar tent array 100 includes at least solar module 110 and solar module 120. In some implementations, solar module 110 and solar module 120 can be coupled (e.g., mechanically coupled, rotatably coupled, etc.). In some implementations, solar module 110 and solar module 120 can be uncoupled. Solar module 110 can have an angular position (or tilt) relative to solar module 120 that defines nonzero angle A between an edge portion of solar module 110 and an edge portion of solar module 120. Solar module 110 includes frame 112. Solar module 120 includes frame 122.

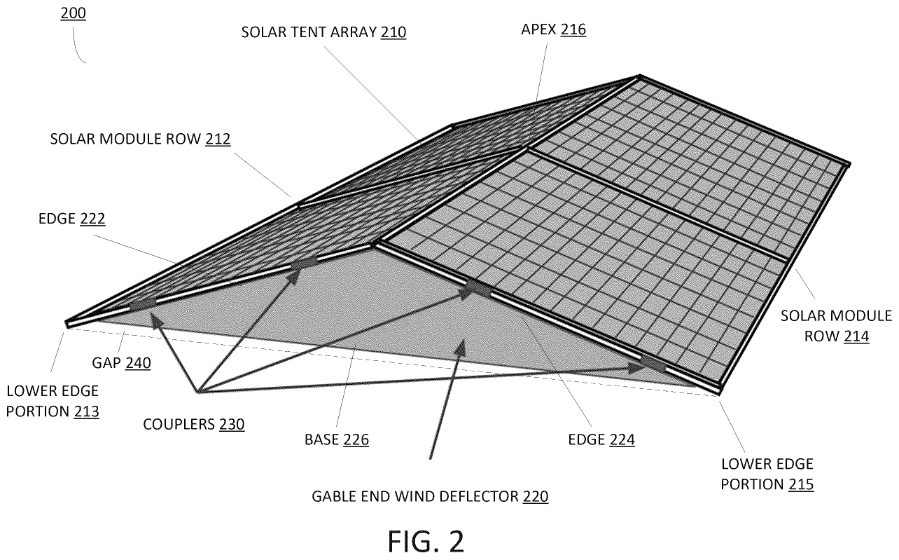

As described above, support structures can be used to reduce (or prevent) lifting of solar modules by strong winds, such as ground anchors, foundation systems, ballast weights, and/or the like. At least to reduce the strength recommended for ground anchors, the strength recommended for a foundation system, and/or the ballast weight recommended to be effective, one or more embodiments set forth herein include a “windshield” (also referred to herein as a wind deflector) for the example solar tent array 100, which can be or include an air dam that is positioned at at least one end of the example solar tent array 100 and that limits or prevents free flow of wind under the example solar tent array 100. In some implementations, such a wind deflector can be configured to limit airflow under the example solar tent array 100 to be substantially no more than a predefined amount. An example implementation of an air dam is shown in FIG. 2.

FIG. 2 depicts a perspective view of a wind deflector system 200 including a gable end wind deflector 220 for a solar tent array 210, according to an embodiment. Solar tent array 210 can be structurally and/or functionally similar to solar tent array 100 of FIG. 1. Solar tent array 210 can be mechanically coupled to gable end wind deflector 220 by couplers 230.

Solar tent array 210 includes solar module row 212, solar module row 214, and apex 216 (e.g., structurally and/or functionally similar to apex 130 of FIG. 1). Apex 216 can define a boundary between solar module row 212 and solar module row 214. Solar module row 212 includes two solar modules (e.g., each being structurally and/or functionally similar to solar module 110 of FIG. 1) and lower edge portion 213. Solar module row 214 includes two solar modules (e.g., each being structurally and/or functionally similar to solar module 120 of FIG. 1) and lower edge portion 215. Lower edge portion 213 can be a portion of solar module row 212 that is nearer a surface supporting solar tent array 210 than remaining portions of solar module row 212. For example, lower edge portion 213 can be a corner portion of a frame of a solar module that is furthest from apex 216 and/or an edge portion of a frame of a solar module that is furthest from apex 216. Similarly, lower edge portion 215 can be such a portion of solar module row 214.

Gable end wind deflector 220 can be and/or include a substantially polygonal (e.g., substantially triangular) shaped rigid, planar material resembling a gable end and configured to reduce (or impede, prevent) airflow through an opening at least partially defined by apex 216 of solar tent array 210. In some implementations, gable end wind deflector 220 can be configured to reduce aerodynamic lifting forces caused by the free flow of air in a space between solar tent array 210 and a surface supporting solar tent array 210 by reducing (or impeding, prevent) airflow through such an opening. In some implementations, gable end wind deflector 220 can be configured to limit airflow through such an opening to a predefined amount. As can be seen in FIG. 2, gable end wind deflector 220 is positioned under solar tent array 210 and between solar module row 212 and solar module row 214. Gable end wind deflector 220 can be made of any of a variety of materials, such as a material(s) that has sufficient durability in an outdoor environment. For example, the material(s) can be or include a durable, thick plastic material. Gable end wind deflector 220 includes edge 222, edge 224, and base portion 226.

As depicted, edge 222 can be disposed between apex 216 and lower edge portion 213 and edge 224 can be disposed between apex 216 and lower edge portion 215. Edge 222 is shown as not being disposed all the way from apex 216 to lower edge portion 213, and edge 224 is shown as not being disposed all the way from apex 216 to lower edge portion 215. Similarly stated, edge 222 is shown as being disposed between apex 216 and a point along an edge of solar module row 212 that is a specified distance from lower edge portion 213. Similarly, edge 224 is shown as being disposed between apex 216 and a point along an edge of solar module row 214 that is a specified distance from lower edge portion 215. As depicted, edge 222 has a length that is about the same as a length of edge 224. As depicted, base portion 226 can be disposed between a gable end of solar module row 212 and a gable end of solar module row 214. As depicted, base portion 226 defines a gap 240 disposed between base portion 226 and a surface supporting solar tent array 210 (and/or a support structure supporting solar tent array 210; not shown in FIG. 2). Gap 240 can be an air gap configured to, for example, facilitate cooling of solar tent array 210, facilitate installation of solar tent array 210 (e.g., to make it easier to install solar tent array 210 on an uneven surface), to facilitate drainage of water therethrough, etc. Gap 240 can have a size of about 1 inch, about 2 inches, about 3 inches, about 4 inches. In some implementations, gap 240 can be sized to conform to an installation (or deployment) surface. For example, gap 240 can be sized to prevent gable end wind deflector 220 from contacting physical objects on a target installation surface such as rocks, vegetation, mounds, and/or the like. In some implementations, gap 240 can include portions that each have a different size. For example, gap 240 can have a first portion with a first size to conform to a first portion of a target installation surface and a second portion with a second size to conform to a second portion of a target installation surface (e.g., a second portion with an elevation different from an elevation of the first portion).

Couplers 230 can be configured to mechanically couple (e.g., attach, secure, etc.) gable end wind deflector 220 to solar tent array 210. Coupler 230 can be and/or include, for example, one or more screws, rivets, clips, adhesives, clamps, and/or the like. For example, as shown in FIG. 2, couplers 230 can include a first pair of couplers that mechanically couple edge 222 to a gable end of solar module row 212 and a second pair of couplers that mechanically couple edge 224 to a gable end of solar module row 214.

In some embodiments, the outer ends of a gable end wind deflector can be disposed on the ground (or any other supporting surface). That is, end portions of each edge that are furthest from apex 216 can be surface-contact portions that contact the ground. Alternatively, in some embodiments, a gable end wind deflector can be installed so as to leave a small air gap between the bottom of the wind deflector and the ground, which can allow (or permit) easy drainage of water, for example, or to ensure that the wind deflector is above any uneven ground between the solar modules. Despite existence of such an air gap beneath the wind deflector, the “air dam” effect would still reduce the wind loads exerting a lifting force on the wind deflector system.

Although solar module row 212 and solar module row 214 are each depicted as including two solar modules, in some embodiments, a solar module row can include any number of solar modules. Although edge 222 is depicted as having a length about the same as a length of edge 224, in some embodiments, a first edge of a gable end wind deflector can have a length different from a length of a second edge of that gable end wind deflector. Although edge 222 and edge 224 are each depicted as being disposed with apex 216, in some embodiments, an edge of a gable end wind deflector can be disposed with a point along a gable end of a solar module row that is a specified distance from the apex. In some such implementations, the edge and the apex can define an air gap between the edge and the apex that can, for example, facilitate cooling of a solar tent array, permit drainage of water therethrough, and/or prevent the base portion of the gable end wind deflector from contacting the ground (e.g., to prevent damage to the gable end wind deflector). Although depicted as being a substantially triangular shaped structure, in some embodiments, a gable end wind deflector can be any polygonal shaped structure, such as a substantially quadrilateral shaped structure, a substantially pentagonal shaped structure, and/or the like. Although depicted as a single gable end wind deflector 220 at a first gable end of solar tent array 210, wind deflector system 200 can include a second gable end wind deflector disposed at an opposite gable end (not shown) of a solar tent array. That is, although obscured in FIG. 2, wind deflector system 200 can include an additional gable end wind deflector on a side of solar tent array 210 opposite to the side of solar tent array 210 associated with gable end wind deflector 220. In some such implementations, the two gable end wind deflectors can be noncontiguous (e.g., not sharing a common border, not touching). In some such implementations, alternatively, the two gable end wind deflectors can be contiguous (e.g., sharing a common border, touching).

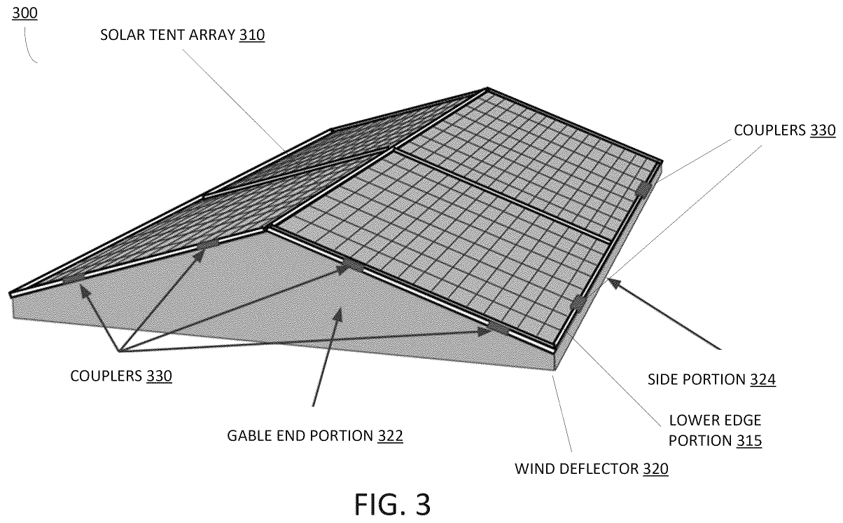

FIG. 3 depicts a perspective view of a wind deflector system 300 including a side portion 324 for a solar tent array 310, according to an embodiment. Wind deflector system 300 includes solar tent array 310, wind deflector 320, and couplers 330. Solar tent array 310 can be structurally and/or functionally similar to the solar tent arrays of the embodiments of FIGS. 1-2. Wind deflector 320 can be mechanically coupled to solar tent array 310 by couplers 330. Wind deflector 320 includes gable end portion 322 (e.g., structurally and/or functionally similar to gable end wind deflector 220 of FIG. 2) and side portion 324. Couplers 330 can be configured to mechanically couple gable end portion 322 to solar tent array 310 and to mechanically couple side portion 324 to lower edge portion 315 (e.g., structurally and/or functionally similar to lower edge portion 215 of FIG. 2) of solar tent array 310.

FIG. 3 shows a further example embodiment of a wind deflector/air dam, in which the solar modules of solar tent array 310 are mechanically supported a non-zero distance above the ground (or another surface) by wind deflector 320 and in which the solar modules of solar tent array 310 do not rest directly on the ground (or other supporting surface). If the supporting surface is level, the wind deflector 320 can be disposed with the supporting surface, entirely or almost entirely blocking any wind or air from flowing under the solar modules of solar tent array 310. FIG. 3 also shows an optional side wind deflector, side portion 324, mounted under lower edge portion 315 of the solar modules of solar tent array 310, to reduce (or to minimize) wind penetration under solar tent array 310 from the side(s) of solar tent array 310 (as opposed to the gable end(s) or front(s) of solar tent array 310). Wind deflector 320 can be configured to block wind from flowing under solar tent array 310, for example when solar tent array 310 is mounted on a separate racking system (not shown) and/or when solar tent array 310 is not mounted on a separate racking system (not shown) and where wind deflector 320 can provide functionality of (or serve) as the racking system. That is, wind deflector 320 can include one or more surface-contact portions configured to mechanically support solar tent array 310 a non-zero distance above the ground (or another surface).

Accordingly, wind deflector 320 is also referred to herein as a lifting wind deflector. In some implementations, wind deflector 320 can be configured to distribute the weight of the solar array across a surface. In some implementations, wind deflector 320 can support the solar modules of solar tent array 310 above the ground (or other surface) and is configured to distribute the weight of the solar modules of solar tent array 310 so that solar tent array 310 does not sink into ground that is either permanently soft, or temporarily softened (e.g., by weather events such as rain).

In some embodiments, a solar tent array, resting (or placed, disposed, etc.) directly on the ground, will concentrate the weight of the solar modules of that solar tent array on a thin linear region where the solar modules rest on their edges. Such concentration of the load on a small portion of the surface can cause the solar tent array to sink into the ground, either continuously (if the ground is permanently soft) or from time to time (if the ground is occasionally softened).

Accordingly, wind deflector 320 can be configured to have surface contact portions with a relatively large surface area. The relatively large surface area can be achieved by making wind deflector 320 from a thick, relatively lightweight material (such as for example a foam or plastic, with a sufficient durability) and/or by constructing wind deflector 320 including a horizontal “footer” surface along the bottom edge of a relatively thin wind deflector material (such as sheet metal or a thin plastic). In some implementations, gable end portion 322 can include such surface contact portions. In some implementations, side portion 324 can include such surface contact portions. In some implementations, each of gable end portion 322 and side portion 324 can include such surface contact portions.

Although depicted as a single gable end portion 322 and a single side portion 324, wind deflector system 300 can include a second gable end wind deflector disposed at an opposite gable end (not shown) of a solar tent array and a second single side portion can be disposed at an opposite side end (not shown) of a solar tent array. That is, although obscured in FIG. 3, wind deflector system 300 can include an additional gable end portion on a side of solar tent array 310 opposite to the side of solar tent array 310 associated with gable end portion 322, and an additional side portion on a side of solar tent array 310 opposite to the side of solar tent array 310 associated with side portion 324. In some such implementations, the two gable end gable end portions can be noncontiguous portions and/or the two side portions can be noncontiguous portions. In some such implementations, alternatively, the two gable end portions can form a single contiguous portion and/or the two side portions can form a single contiguous portion.

FIG. 4 depicts a perspective view of a wind deflector system 400 including upturned portions 426 for a solar tent array 410, according to an embodiment. Wind deflector system 400 includes solar tent array 410 (e.g., structurally and/or functionally similar to the solar tent array of any of the embodiments of FIGS. 1-3), wind deflector 420, and couplers 430 (e.g., structurally and/or functionally similar to couplers 330 of FIG. 3). Wind deflector 420 includes gable end portion 422 and side portion 424. Gable end portion 422 can be structurally and/or functionally similar to gable end portion 322 of FIG. 3 with the addition of upturned portions 426. Similarly, side portion 424 can be structurally and/or functionally similar to side portion 324 of FIG. 3 with the addition of upturned portions 426. Although obscured in FIG. 4, wind deflector system 400 can include an additional gable end portion on a side of solar tent array 410 opposite to the side of solar tent array 410 associated with gable end portion 422, and an additional side portion on a side of solar tent array 410 opposite to the side of solar tent array 410 associated with side portion 424.

FIG. 4 shows a variation on the configuration shown in FIG. 3, in accordance with some embodiments. In FIG. 4, wind deflector 420 has upturned portions 426, giving wind deflector 420 some resemblance to a handlebar mustache. Upturned portions 426 can be portions of wind deflector 420 configured to be disposed above lower edge portion(s) (e.g., lower edge portion 213 and lower edge portion 215 of FIG. 2; not shown in FIG. 4) of solar tent array 410 at a point along a length of a lower edge portion and to prevent lateral movement of solar modules towards the surface (or away from an apex of solar tent array 410). That is, the upturned portions 426 enable the solar modules of solar tent array 410 to be rested (or placed, disposed, etc.) on and supported by wind deflector 420 without the solar modules of solar tent array 410 sliding down the slope of gable end portion 422 before the solar modules of solar tent array 410 can be fixed in place by couplers 430. Accordingly, upturned portions 426 are also referred to herein as “mustache stops.”

As depicted, wind deflector system 400 includes six upturned portions 426. Four upturned portions from upturned portions 426 are disposed with different lower corner portions of solar tent array 410 and are depicted as being portions of gable end portion 422. The remaining two upturned portions are depicted as being portions of side portion 424, with a first upturned portion being disposed with a lower edge portion of solar tent array 410 that is about aligned with boundary 412 and a second upturned portion being disposed with a lower edge portion of solar tent array 410 that is about aligned with boundary 414. As depicted, boundary 412 can be a boundary between two solar modules of a solar module row of solar tent array 410 that is on one side of an apex of solar tent array 410. Similarly, boundary 414 can be a boundary between two solar modules of a solar module row of solar tent array 410 that is on the opposite side of the apex of solar tent array 410. Although six upturned portions are depicted, in some embodiments, a wind deflector system can include any number of upturned portions.

A consideration of the configurations shown in FIGS. 2-4 and in particular FIGS. 3-4 is that a lack of air flow beneath the solar modules of a solar tent array can raise the temperature of the solar modules, measurably reducing efficiency. To mitigate this, and in accordance with some embodiments, a wind deflector can have a surface defining openings that allow (or permit) a limited (or predefined) amount of airflow therethrough. Alternatively or in addition, a gap between the wind deflectors and the solar modules can be used. For example, a gap can include a lateral gap associated with a wind deflector and/or a vertical gap associated with a wind deflector, as described in further detail herein. Alternatively or in addition, a small gap can exist between the solar modules at the apex of the solar tent array, which is also referred to herein as a ridge line gap or an apex gap or a lateral gap associated with solar modules. Stated similarly, an apex of a solar tent array can define a ridge line gap disposed between two solar modules Warm air will tend to exit from a space beneath the solar tent array through a ridge line gap, pulling cool air into the space beneath the solar tent array through the openings in the surface of a wind deflector (or through any vertical gap between the bottom of the wind deflector at the ground, or through any lateral gap between a standoff wind deflector and a solar module) and thus helping to cool the solar modules of the solar tent array. In addition, as winds flow across the solar tent array, the need for the air to shift from flowing up one side of the tent to flowing down the other side will result in a pressure drop at the apex of the solar tent array: as air pressure in the space below the solar tent array equalizes through the ridge line gap between the solar modules, it will create a net down-force on the solar modules of the solar tent array, helping to hold the solar modules of the solar tent array downwards (e.g., towards the surface).

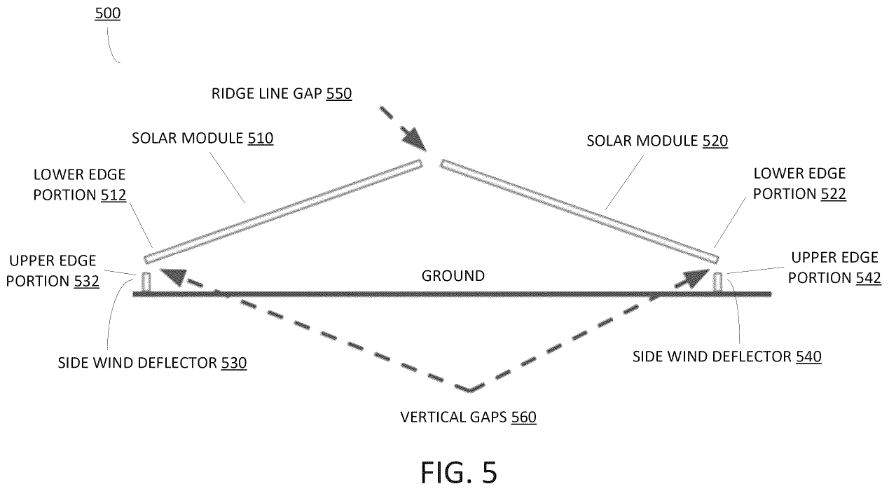

FIG. 5 depicts a cross-sectional view of a wind deflector system 500 including side wind deflectors defining vertical gaps 560, according to some embodiments. Wind deflector system 500 includes solar module 510, solar module 520, side wind deflector 530 and side wind deflector 540. In some implementations, wind deflector system 500 can additionally include gable end wind deflectors (e.g., gable end wind deflector(s) of any of the embodiments of FIGS. 2-4; not shown in FIG. 5).

Solar module 510 and solar module 520 can be configured in a solar tent array and can define ridge line gap 550 at an apex of the solar tent array. Solar module 510 includes lower edge portion 512. Lower edge portion 512 can be and/or include an edge and/or corner (or other portions) of solar module 510 that are farther from ridge line gap 550 than remaining edges and/or corners of solar module 510. Solar module 520 includes lower edge portion 522. Lower edge portion 22 can be and/or include an edge and/or corners (or other portions) of solar module 520 that are farther from ridge line gap 550 than remaining edges and/or corners of solar module 520.

Side wind deflector 530 includes upper edge portion 532. Upper edge portion 532 can be and/or include an edge and/or corner (or other portions) of side wind deflector 530 that are farther from the ground than remaining edges and/or corners of side wind deflector 530. Side wind deflector 530 can define a first vertical gap from vertical gaps 560 between upper edge portion 532 of side wind deflector 530 and lower edge portion 512 of solar module 510. Side wind deflector 540 includes upper edge portion 542. Upper edge portion 542 can be and/or include an edge and/or corner (or other portions) of side wind deflector 540 that are farther from the ground than remaining edges and/or corners of side wind deflector 540. Side wind deflector 540 can define a second vertical gap from vertical gaps 560 between upper edge portion 542 of side wind deflector 540 and lower edge portion 522 of solar module 520.

FIG. 5 shows an end view of a pair of “tent” solar module sets including solar module 510 and solar module 520, with side wind deflectors including side wind deflector 530 and side wind deflector 540, showing gaps between the solar modules at the top (i.e., ridge line gap 550) and between the solar modules and the side wind deflectors (i.e., vertical gaps 560), in accordance with some embodiments. Not shown in FIG. 5 are the couplers (e.g., fixtures, etc.) that can attach side wind deflector 530 to solar module 510 and side wind deflector 540 to solar module 520 at the respective sides, or that couple (e.g., attach, etc.) solar module 510 to solar module 520 at and/or along the axis (not shown in FIG. 5) of the solar tent array associated with ridge line gap 550.

Other wind deflector placements, relative to the solar modules, are also contemplated by the present disclosure. For example, the wind deflectors can be separated laterally a small distance clear of the solar modules, leaving a lateral gap between the wind deflectors and the solar modules, but with the wind deflectors made tall enough to deflect wind above the solar modules while, at the same time, allowing slow-moving air to enter a space under the solar modules for cooling purposes. Such wind deflectors are also referred to herein as standoff wind deflectors.

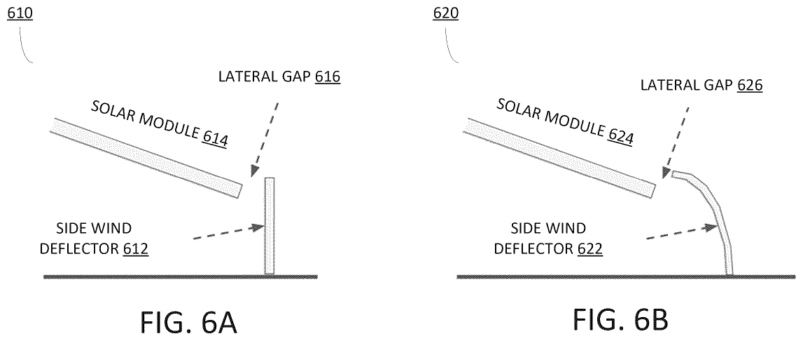

FIGS. 6A-6B each show a standoff side wind deflector placed to deflect airflow from the side of the solar module (e.g., from a lower edge portion of the solar module) over the top of the solar module (e.g., over a sloped surface of the solar module and past an apex of the solar tent array), while leaving a lateral gap between the standoff side wind deflector and the solar module edge so that cooling air can enter, in accordance with some embodiments. The wind deflector at the “gable end” of the solar tent array (e.g., the gable end wind deflector of any of the embodiments of FIGS. 2-4) can optionally be similarly positioned in a standoff position, deflecting airflow over the solar modules while leaving a lateral gap where cooling air can enter slowly and circulate in a space under the solar modules to carry away heat. In some implementations, the wind deflector can be connected/attached to the tent array via one or more connector members (e.g., ribs, spines, stanchions, standoffs, etc.). Where multiple connector members are used, the connector members can be spaced apart from one another by a preselected distance.

FIG. 6A depicts a detailed partial cross-sectional view of a wind deflector system 610 including a vertical wall side wind deflector defining a lateral air gap, according to an embodiment. Wind deflector system 610 includes side wind deflector 612 and solar module 614 (e.g., structurally and/or functionally similar to a solar module of any of the embodiments of FIGS. 1-5). Side wind deflector 612 can be a standoff side portion configured as a vertical wall (i.e., vertical relative to the surface) and positioned to deflect airflow from the lower edge portion of a frame of solar module 614 over an active surface of solar module 614 and positioned to define lateral gap 616 disposed laterally between side wind deflector 612 and the lower edge portion of the frame of solar module 614. In some implementations, side wind deflector 612 can be configured to be rigidly connected to the lower edge portion of the frame of solar module 614 at one or more points along a length of side wind deflector 612. Although depicted as being about as high as the lower edge portion of solar module 614, in some embodiments, a standoff side wind deflector can have a height different than (e.g., greater than, less than) a height of the lower edge portion of solar module 614.

FIG. 6B depicts a detailed partial cross-sectional view of a wind deflector system 620 including a scoop side wind deflector defining a lateral air gap, according to an embodiment. Wind deflector system 620 includes side wind deflector 622 and solar module 624 (e.g., structurally and/or functionally similar to a solar module of any of the embodiments of FIGS. 1-6A). Side wind deflector 622 can be a standoff side portion configured as a concave downward scoop and positioned to deflect airflow from the lower edge portion of a frame of solar module 624 over an active (upper, sun-facing) surface of solar module 624 and positioned to define lateral gap 626 disposed laterally between side wind deflector 622 and the lower edge portion of the frame of solar module 624. In some implementations, side wind deflector 622 can be configured to be rigidly connected to the lower edge portion of the frame of solar module 624 at one or more points along a length of side wind deflector 622. Although depicted as being about as high as the lower edge portion of solar module 624, in some embodiments, a standoff side wind deflector can have a height different than (e.g., greater than, less than) a height of the lower edge portion of solar module 624.

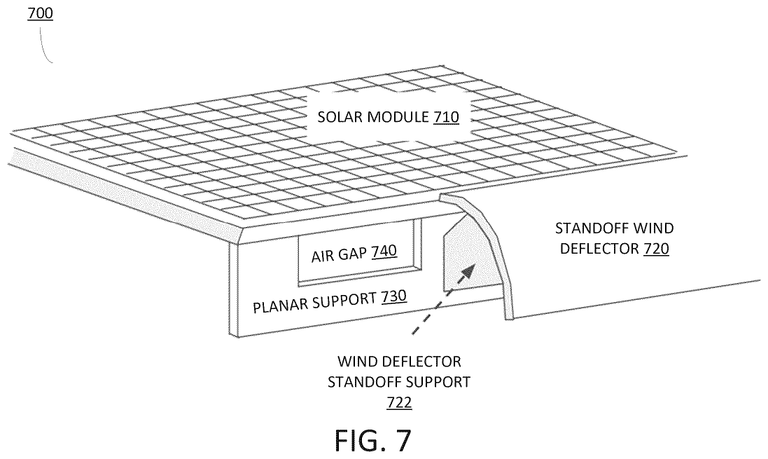

FIG. 7 depicts a detailed, cutaway perspective view of a wind deflector system 700 including a planar support 730 for mechanically supporting a solar module 710, according to an embodiment. Wind deflector system 700 includes solar module 710 (e.g., structurally and/or functionally similar to the solar module of any of the embodiments of FIGS. 1-6B), a standoff wind deflector 720 (e.g., structurally and/or functionally similar to side wind deflector 622 of FIG. 6B), and a planar support 730. As depicted, planar surface 730 can include a surface(s) that define air gap 740 therethrough. Standoff wind deflector 720 includes wind deflector standoff support 722.

In some embodiments, a standoff wind deflector (e.g., a wind deflector with a standoff gable end portion and/or with a standoff side portion) can be attached to a planar support that also supports the weight of the solar module(s). FIG. 7 shows a cutaway perspective view illustrating how such a structure may be implemented, in accordance with some embodiments. For purposes of illustration, a portion of standoff wind deflector 720 in FIG. 7 has been cut away on the left side to show the underlying planar support 730 that supports the weight of the solar module 710. The standoff wind deflector 720 can be attached to the planar support 730 by one or more wind deflector standoff support 722. Wind deflector standoff support 722 can be and/or include a planar lower portion attached to planar support 730 and a bent upper portion that makes a point line attachment to standoff wind deflector 720. In some implementations, wind deflector standoff support 722 can be a part of (e.g., monolithically formed with) standoff wind deflector 720. The planar support 730 can be configured to allow air to pass through a space under the solar module 710. FIG. 7 shows air gap 740 to allow this, however the shape and size of the air gaps can be determined by the specific configuration of the support structure. In some implementations, the standoff wind deflector 720 can define lateral air gap similar to the one shown in FIG. 6B. In some implementations, wind deflector system 700 can be absent of a lateral air gap such as the lateral air gap shown in FIG. 6B. Although depicted as a scoop concave down standoff, in some embodiments, a standoff wind deflector can be a scoop concave up standoff, a vertical wall standoff, an angled standoff, and/or the like.

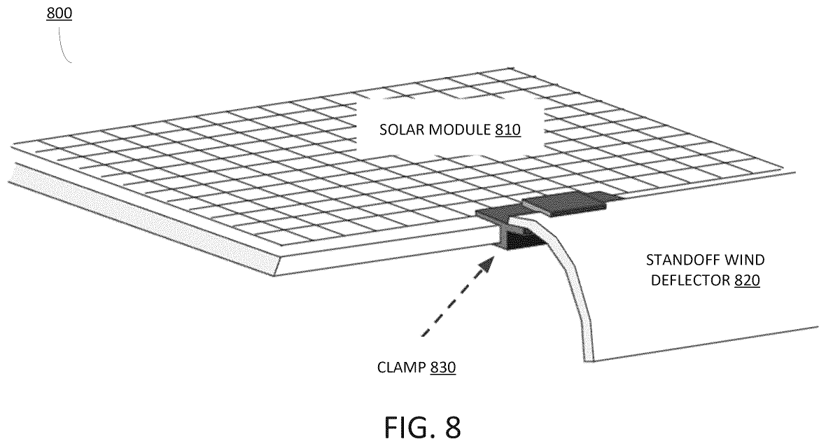

FIG. 8 depicts a detailed, cutaway perspective view of a wind deflector system 800 including a standoff wind deflector 820 providing functionality of a planar support for a solar module 810, according to an embodiment. Wind deflector system 800 includes solar module (e.g., structurally and/or functionally similar to the solar module of any of the embodiments of FIGS. 1-7), standoff wind deflector 820 (e.g., structurally and/or functionally similar to standoff wind deflector 720 of FIG. 7), and clamp 830.

Alternatively, or in addition to those set forth with respect to FIGS. 1-7, standoff wind deflector 820 (e.g., positioned at a gable end or a side of a solar tent array) can itself be the supporting structure.

FIG. 8 shows a detailed, cutaway perspective view illustrating how standoff wind deflector 820 can be implemented, in accordance with some embodiments. For purposes of illustrations, a portion of standoff wind deflector 820 has been cut away, as was done in FIG. 7. In FIG. 8, however, the cutaway shows that there is no underlying supporting structure separate from standoff wind deflector 820. Instead, clamp 830 (or one or more other coupler systems as described herein) rigidly connect solar module 810 to standoff wind deflector 820 at one or more points along its length (optionally leaving an air gap between each pair of clamps/attachment systems), so that standoff wind deflector 820 both provides the wind deflector effect and serves as a supporting structure. The substantially rigid connections (such as clamp 830) between standoff wind deflector 820 and solar module 810 can be configured (e.g., sized, shaped, and made of a material(s)) to resist the bending moment that results from the mechanical configuration.

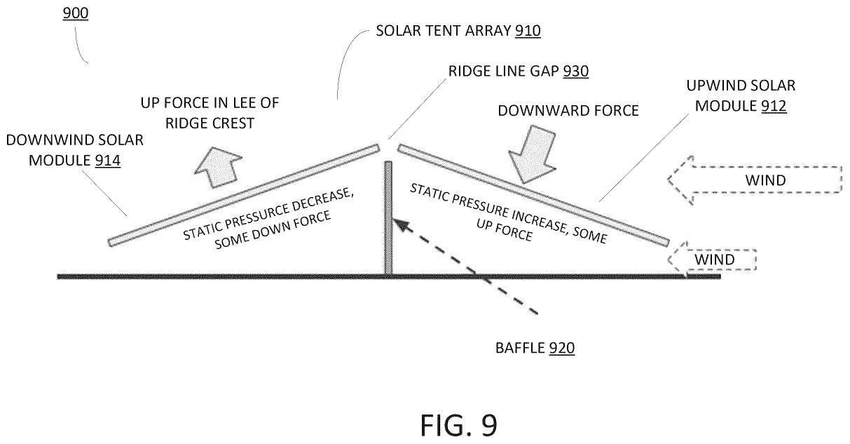

FIG. 9 depicts a cross-sectional view of a wind deflector system 900 including a baffle 920 for a solar tent array 910, according to an embodiment. System 900 includes solar tent array 910 (e.g., structurally and/or functionally similar to the solar tent arrays of any of the embodiments of FIGS. 1-8), and baffle 920. Solar tent array 910 defines ridge line gap 930 (e.g., structurally and/or functionally similar to ridge line gap 550 of FIG. 5). Solar tent array 910 includes an upwind solar module 912 and a downwind solar module 914.

FIG. 9 shows an implementation of a wind deflector system including baffle 920 alternatively (or in addition) to side wind deflectors (not shown in FIG. 9), in accordance with some embodiments. Winds from the side will tend to press down on the upwind solar module 912 and will tend to lift up the downwind solar module 914 (in the lee of the ridgeline of solar tent array 910). Rather than use side wind deflectors to prevent wind from getting under the upwind solar module 912 and the downwind solar module 914, wind deflector system 900 allows wind to enter under the lower edge of the upwind (or upstream) solar module 912 but also adds baffle 920 under the ridgeline of the tent. The expanding space under the upwind solar module 912 and the presence of baffle 920 (which will reduce or stop/block the wind that enters under the upwind solar module 912), collectively, can increase the static pressure under the upwind solar module 912, thereby at least partly offsetting the downward force (or downforce) caused by wind striking the top of the upwind solar module 912.

As shown in FIG. 9, on the downwind side, there is an upforce (or upward force) on the downwind solar module 914 due to air flowing over the top of the ridgeline of solar tent array 910. At the same time, the baffle 920 can prevent the wind passing under the solar tent array 910 from creating an upforce from below; instead, given the wind direction, the baffle 920 will slightly decrease the static pressure under the downwind solar module 914, helping to offset the upforce from air flowing over the top.

As depicted, baffle 920 can be disposed between upwind solar module 912 and downwind solar module 914. Optionally, the baffle 920 can provide structural support to the solar tent array 910, for example to a center portion (e.g., a portion aligned with an apex of the solar tent array) of the solar tent array 910. For example, the upper edges of each of the upwind solar module 912 and the downwind solar module 914 can be clamped, clipped, or otherwise fastened and/or secured to the top of the baffle 920. Although depicted as being perpendicular to the surface, in some embodiments, a baffle can be slanted relative to the surface to define a non-perpendicular angle relative to the surface. Although depicted as being planar, in some embodiments, a baffle can have a swoop-like shape (e.g., a scoop as described herein) where an upper portion of the swoop can be disposed with, near, or at ridge line gap 930.

As in at least FIG. 5, FIG. 9 shows ridge line gap 930 between the upwind solar module 912 and the downwind solar module 914 along the ridgeline of the solar tent array 910. In some implementations, the ridge line gap 930 can be interrupted by any couplers (e.g., clamps, etc.) attaching the upwind solar module 912 and the downwind solar module 914 to the baffle 920 and/or attaching the upwind solar module 912 to the downwind solar module 914. The ridge line gap 930 allows air flowing (slowly) under the solar modules to carry away heat.

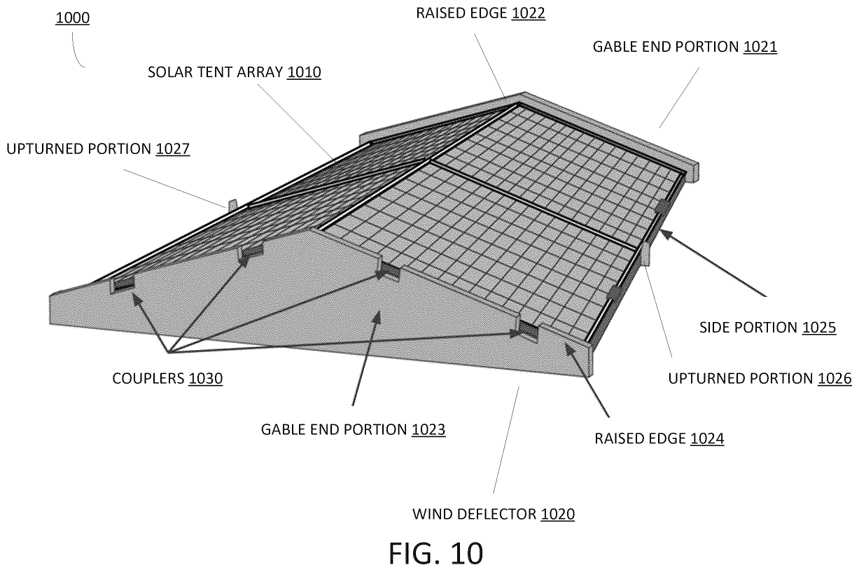

FIG. 10 depicts a perspective view of a wind deflector system 1000 including raised edges disposed above a solar tent array 1010, according to an embodiment. Wind deflector system 1000 includes solar tent array 1010 (e.g., structurally and/or functionally similar to the solar tent array of any of the embodiments of FIGS. 1-9), wind deflector 1020, and couplers 1030 (e.g., structurally and/or functionally similar to the couplers of any of the embodiments of FIGS. 2-4). Couplers 1030 can be configured to mechanically couple wind deflector 1020 to solar tent array 1010.

Wind deflector 1020 includes gable end portion 1021, gable end portion 1023, and side portion 1025. Gable end portion 1021 includes raised edge 1022. Gable end portion 1023 includes raised edge 1024 (shown, for purposes of illustrating couplers 1030, with cutouts that depict approximate positions of couplers 1030 with respect to gable end portion 1023). Although not depicted, gable end portion 1021 can also include couplers 1030 that mechanically couple gable end portion 1021 to solar tent array 1010. Each of raised edge 1022 and raised edge 1024 can be disposed above solar tent array 1010 (e.g., above an active solar surface of solar tent array 1010). Accordingly, wind deflector 1020 is also referred to herein as a raised-edge wind deflector. Side portion 1025 includes upturned portion 1026 (e.g., structurally and/or functionally similar to upturned portions 426 of FIG. 4). Although obscured in FIG. 10, wind deflector 1020 can include an additional side portion on a side of solar tent array 1010 opposite to the side of solar tent array 1010 associated with side portion 1025. The additional side portion (not shown in FIG. 10) can include upturned portion 1027 (e.g., structurally and/or functionally similar to upturned portions 426 of FIG. 4).

As depicted, solar tent array 1010 can be disposed between gable end portion 1021 and gable end portion 1023. In some implementations, gable end portion 1021 and/or gable end portion 1023 can be at least partially disposed between solar tent array 1010 and a surface beneath solar tent array 1010. For example, a ledge portion (not shown in FIG. 10) of gable end portion 1021 and/or a ledge portion (not shown in FIG. 10) of gable end portion 1023 can be disposed between solar tent array 1010 and a surface beneath solar tent array 1010 while raised edge 1024 and raised edge 1022 can be disposed above solar tent array 1010.

In some embodiments, if the upper edge of a wind deflector is disposed above the upper surface of a solar module(s) (as shown in FIG. 10), the upper edge of the wind deflector can create an aerodynamic spoiler that can significantly reduce the lifting forces on the solar module due to wind. This is analogous to the aerodynamic spoilers used by sailplanes (i.e., high-performance gliders), high-performance airplanes and airliners to reduce their aerodynamic efficiency to help them descend more quickly. Such aerodynamic spoilers are structures that extend upward from the upper surface of the wing to deflect airflow up and away from the wing surface. This results in the formation of aerodynamic eddies and rotors behind the spoilers, which do not efficiently generate lifting forces on the wing. Disposing a portion of the wind deflector above the upper surface of the solar module(s) can achieve a similar effect, reducing the lifting forces generated by winds over the solar tent array. This is shown in FIG. 10, where raised edge 1024 and raised edge 1022 can each reduce airflow, reduce lift, and increase downforce with respect to solar tent array 1010. The configuration of FIG. 10 can alternatively or additionally be applied to side wind deflectors, if fitted and/or present.

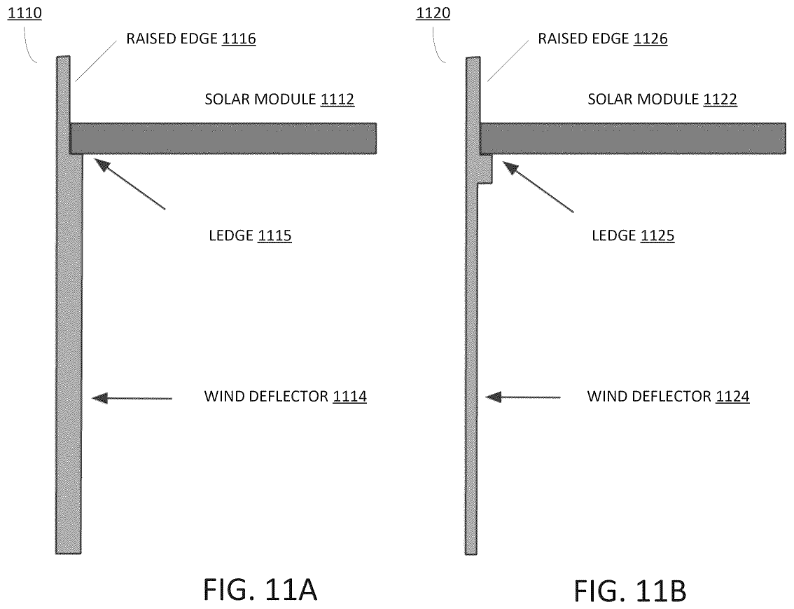

In some embodiments, the raised-edge wind deflector can serve both as an aerodynamic spoiler and as a support for the solar modules of the solar tent array. For example, the wind deflector can have a ledge on an interior side thereof, that supports the solar modules. FIGS. 11A-11B illustrates two example partial cross-sections of wind deflectors with suitable ledges to provide support for solar modules. The partial cross-sections of FIGS. 11A-11B each include a slice of a portion of a wind deflector system as viewed from a side of the gable end wind deflector and a side of a solar module. That is, the solar modules in FIGS. 11A-11B can be angled “up” (e.g., towards an apex of a solar tent array) or “down” (e.g., away from an apex of a solar tent array) and the ledges in FIGS. 11-11B can “run up” (e.g., have a slope towards an apex of a solar tent array) or “run down” (e.g., have a slope away from an apex of a solar tent array) beneath the solar modules, depending on the slice of the portion of the wind deflector system. In some embodiments, a side wind deflector (or a side portion of a wind deflector) can have a ledge that is functionally similar to the ledges of FIGS. 11A-11B. In some such implementations, the ledge of the side wind deflector can be sized and shaped to support a solar module that is tilted with respect to a surface beneath the solar module, for example a solar module of a solar tent array.

FIG. 11A depicts a partial cross-sectional view of a wind deflector system 1110 including a type of ledge for mechanically supporting a solar module 1112, according to an embodiment. Wind deflector system 1110 includes solar module 1112 (e.g., structurally and/or functionally similar to the solar module of any of the embodiments herein) and wind deflector 1114. Wind deflector 1114 can be a gable end wind deflector (or a gable end portion of a wind deflector). Wind deflector 1114 includes ledge 1115 and raised edge 1116 (e.g., structurally and/or functionally similar to the raised edges of FIG. 10). Ledge 1115 can be a long support portion of wind deflector 1114 disposed between solar module 1112 and a surface beneath solar module 1112. As depicted, ledge 1115 can be configured to at least partially mechanically support a portion of solar module 1112. As depicted, solar module 1112 can be disposed between the raised edge 1116 and the ledge 1115 when wind deflector 1114 is in use.

FIG. 11B depicts a partial cross-sectional view of a wind deflector system 1120 including a type of ledge for mechanically supporting a solar module 1122, according to an embodiment. Wind deflector system 1120 includes solar module 1122 (e.g., structurally and/or functionally similar to the solar module of any of the embodiments herein) and wind deflector 1124. Wind deflector 1124 can be a gable end wind deflector (or a gable end portion of a wind deflector). Wind deflector 1124 includes ledge 1125 and raised edge 1126 (e.g., structurally and/or functionally similar to the raised edges of FIG. 10). Ledge 1125 can be a short support portion of wind deflector 1114 disposed between solar module 1122 and a remaining portion of wind deflector 1114 beneath solar module 1122. As depicted, ledge 1125 can be configured to at least partially mechanically support a portion of solar module 1122. As depicted, solar module 1122 can be disposed between the raised edge 1126 and the ledge 1125 when wind deflector 1124 is in use.

In some embodiments, a wind deflector and/or a baffle can be used to protect cables and power electronics associated with solar modules of a solar tent array. Cables and connectors can be at least partially mechanically supported by the wind deflectors, keeping such cables and connectors clear of the ground while also providing protection from the damaging effects of sunlight (which can, for example, destroy insulating plastics and cable-mounting ties and clips over multi-decade periods). Power electronics can similarly be mechanically coupled (e.g., fastened, etc.) to a wind deflector, thereby keeping the power electronics protected from for example standing water, rain and sunlight.

In some embodiments, when a wind deflector and/or a baffle is sufficiently thick (e.g., as described with respect to FIG. 3), sensitive electrical equipment (e.g., power electronics, cables, connectors, etc.) can be disposed inside the wind deflector and/or the baffle providing an additional level of protection.

In one or more embodiments set forth herein, the use of wind deflectors, e.g., when opaque, can alternatively or additionally exhibit an additional benefit by preventing sunlight from reaching the ground under the tent arrays. The lack of sunlight can inhibit or entirely prevent the growth of plants (such as grasses or bushes) under the solar tent array, eliminating the need to cut away growth that could otherwise threaten to lift or damage the solar tent array or its wiring.

In one or more embodiments set forth herein, the wind deflectors can alternatively or additionally inhibit small animals from going under the solar tent array, where they may potentially damage the solar tent array or its wiring. The wind deflectors will naturally provide some inhibition to some types of animal, they can also be configured to gradually emit one or more substances to deter animal life, e.g., by allowing deterrent chemicals to emerge slowly from internal reservoirs through small holes in the material of the wind deflectors. Alternatively or in addition, the wind deflectors can be configured to emit sound (e.g., ultrasonic waves) and/or vibration to deter animal life using for example speakers and/or motors (e.g., eccentric rotating mass motors), actuators (e.g., linear resonant actuators), and/or the like.

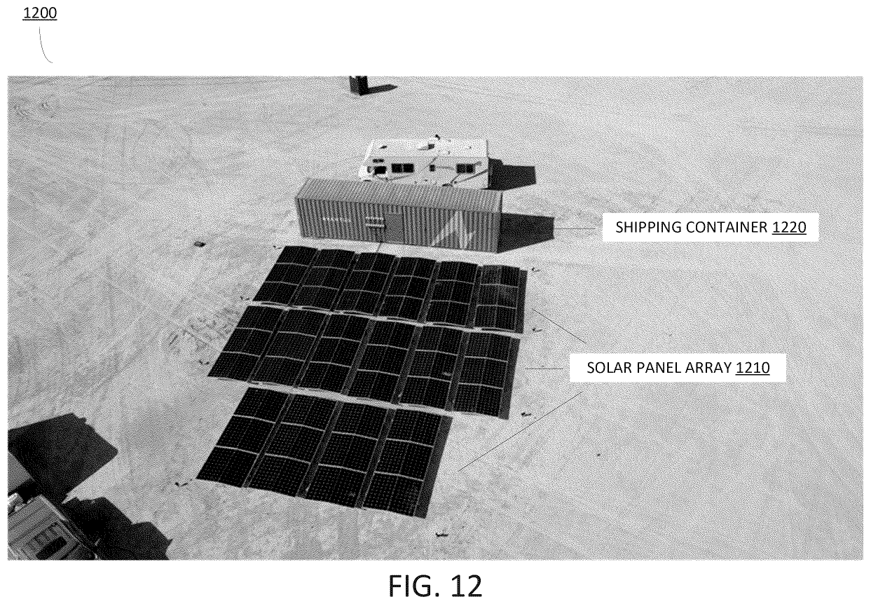

FIG. 12 is an image of an example transportable solar microutility system 1200, according to an embodiment. The example transportable solar microutility system 1200 (or simply, the system 1200) includes solar panel array 1210 and shipping container 1220. In some implementations, the system 1200 can include the wind deflectors of any of the embodiments of FIGS. 2-11B. In some implementations, shipping container 1220 can be configured to store and/or transport solar panel array 1210, and can optionally be configured to store and/or transport the wind deflectors of any of the embodiments of FIGS. 2-11B. FIG. 12 shows an example implementation/deployment of a transportable solar microutility system 1200, with a three-row solar panel array 1210 in the foreground and a 40 foot shipping container 1220 immediately behind it. The Class C recreational vehicle (RV) behind the shipping container 1220 provides a sense of scale, and while not part of the transportable solar microutility system itself, such a vehicle can be an example of a user load associated with solar panel array 1210. The depicted solar microutility system 1200 is capable of serving and/or is configured to serve (e.g., provide power to) five or six of such RVs, assuming typical alternating current (AC) usage.

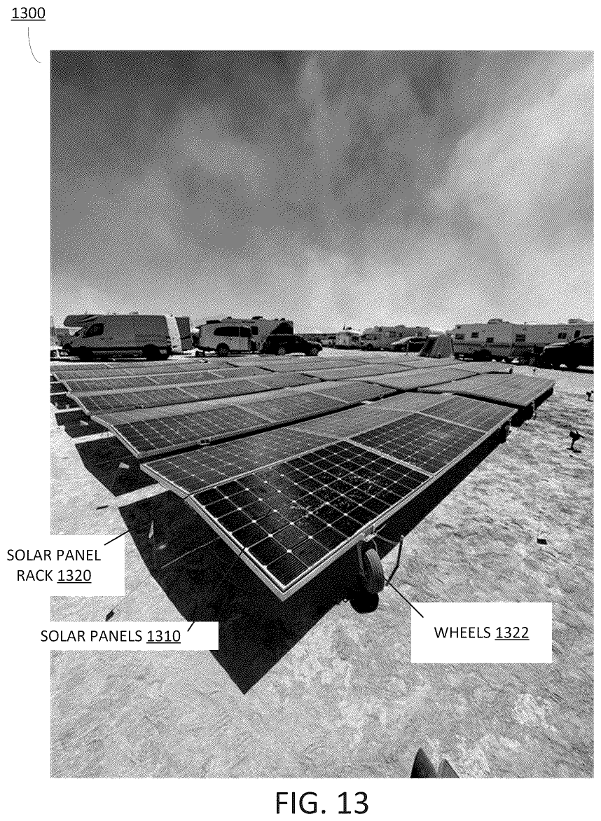

Solar panel array 1210 includes 16 solar tent arrays and has a total of 96 solar panels, where each solar tent array includes 6 solar panels. The solar panels are pre-mounted on solar panel “racks,” as shown in FIG. 13 below. In some implementations, solar panel array 1210 can include for each solar tent array, or a subset thereof, one or more wind deflector(s) as described herein.

FIG. 13 is an image of an example solar panel rack 1320 of a transportable solar microutility system 1300, according to an embodiment. The transportable solar microutility system 1300 (or simply, the system 1300) includes solar panels 1310 and solar panel rack 1320. The solar panels 1310 are mounted on the solar panel racks 1320 in a flat inverted “V” configuration with the long axis of the array oriented north-south. The flat inverted “V” configuration provides for water runoff in the event of rain; and the north-south array axis results in the solar panels 1310 being tilted east or west, improving their morning power output and afternoon power output slightly (at the expense of modestly lower noon-time output). In the example of FIG. 13, the solar panel racks 1320 are equipped with wheels 1322, which make it easier to reposition the solar panels 1310 of a solar panel array, and which also lift/maintain the solar panel arrays clear of the ground.

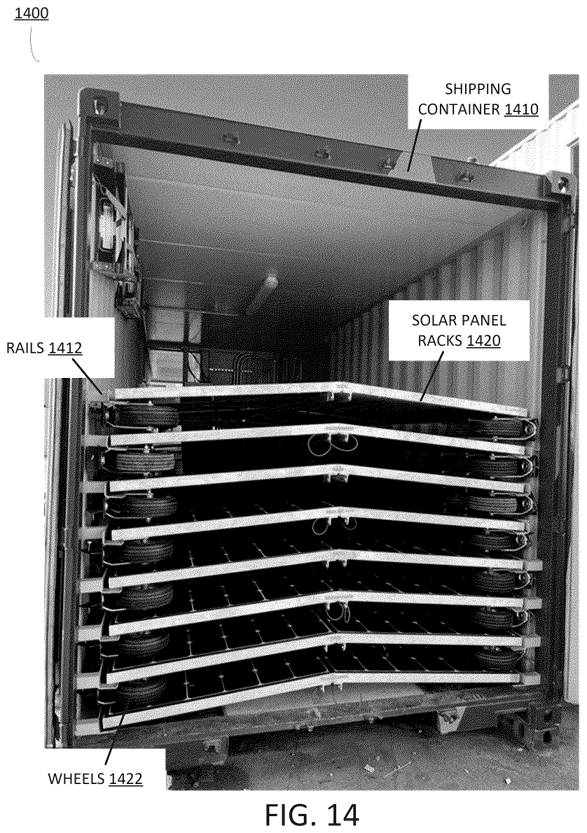

The solar panel racks 1320 can be installed in a shipping container (e.g., the shipping container 1220 of FIG. 12), for example for transportation, by lifting solar panel racks 1320 and sliding solar panel racks 1320 along rails on the sides of the shipping container (not shown in FIG. 3), in a manner similar, for example, to the manner in which bakeries store racks of bread. In the example of FIG. 14, both ends of the shipping container have doors, so there are two sets of rails, one accessible from each end.

FIG. 14 is an image of an example system 1400 for storing solar panel racks within a shipping container 1410, according to an embodiment. FIG. 14 shows how the solar panel racks 1420 (e.g., structurally and/or functionally similar to solar panel racks 1320 of FIG. 13) are stored inside the shipping container 1410 (e.g., structurally and/or functionally similar to shipping container 1220 of FIG. 12) and on rails 1412. The wheels 1422 of solar panel racks 1420 can either be folded (as shown in FIG. 14) or in some embodiments removed, to minimize the distance between adjacent solar panel racks 1420.

When the solar panel racks 1420 are in the shipping container 1410 (as shown in FIG. 14), an interior space exists between the inside ends of the solar panel racks 1420 on one side and the inside ends of the solar panel racks 1420 on the other side. This space in some implementations accommodates the electrical equipment: battery energy storage system (BESS), energy management system, input connections from the solar array and output connections to the customer loads. In some implementations, a solar panel rack 1420 can be coupled to one or more wind deflector(s) as described herein.

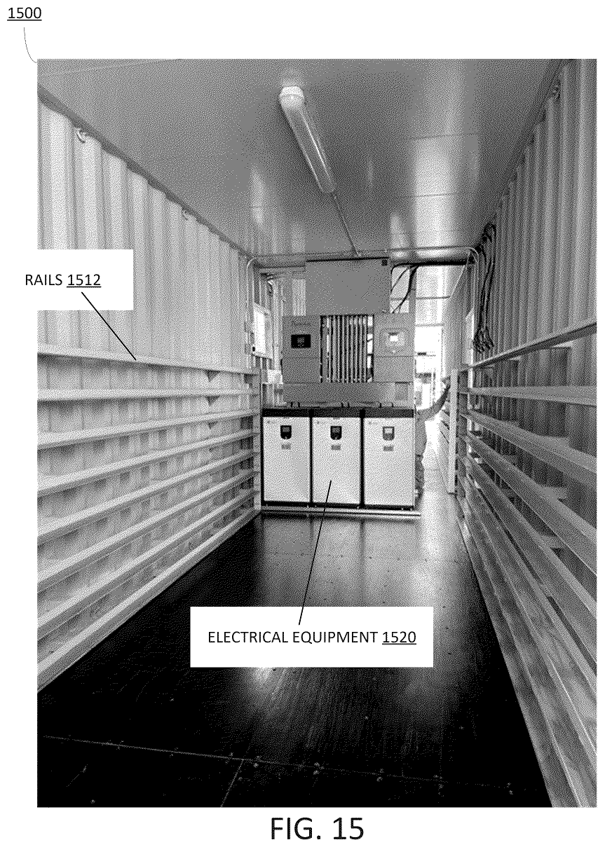

FIG. 15 is an image of example electrical equipment 1520 configured in stored positions within a shipping container 1500, according to an embodiment. FIG. 15 shows a view of the example electrical equipment 1520 at the center of a shipping container, when solar panel racks (e.g., solar panel racks 1420 of FIG. 14) have been removed from stored positions on rails 1512. In some implementations, the electrical equipment 1520 is permanently installed in the shipping container, which means the shipping container 1500 is not only for transportation, but rather can be part of a transportable solar microutility system when the transportable solar microutility system is operating. In some implementations, shipping container 1500 can be configured to store and transport one or more wind deflector(s) as described herein.

Because transportable solar microutility systems described herein may be deployed to remote locations, they can in some implementations be equipped with satellite communication systems (not shown), e.g., to facilitate remote management and monitoring of the transportable solar microutility system.

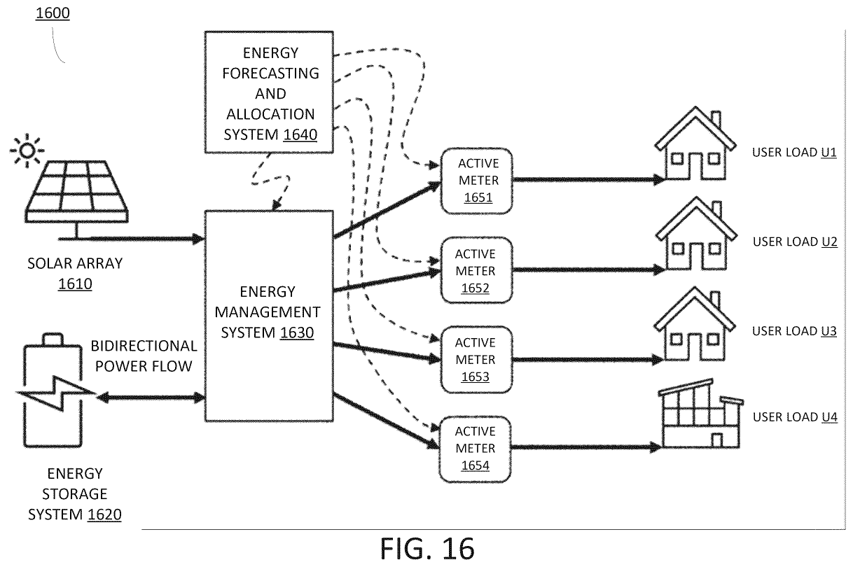

FIG. 16 is a diagram of example microgrid system 1600 for microgrid metering and energy allocation, according to an embodiment. The example microgrid system 1600 can be compatible with one or more embodiments of the present disclosure. The example microgrid system 1600 includes solar array 1610, energy storage system 1620, energy management system 1630, energy forecasting and allocation system 1640, active meter 1651, active meter 1652, active meter 1653, and active meter 1654, which can be coupled (e.g., electrically coupled, communicatively coupled, operatively coupled) together.

Solar array 1610 can be and/or include an array of one or more solar panels (or solar modules), for example an array of solar modules in accordance with embodiments described herein. For example, solar array 1610 can be and/or include a solar tent array(s) including solar modules configured in an inverted “V” configuration, as described herein with respect to FIG. 1. In some implementations, solar array 1610 includes one or more solar tent arrays as described herein, some or all of which may include one or more wind deflector(s) as described herein.

Energy storage system 1620 can be and/or include a battery energy storage system (BESS) including batteries, power conversion systems (e.g., rectifiers, inverters, etc.), and/or battery management systems (e.g., a processor, a memory), for the storage of energy output by solar array 1610 and/or release of energy associated with solar array 1610.

Energy management system 1630 can be and/or include an electric bus configured to distribute electric power based on load demand (e.g., based on user load U1, user load U2, user load U3, and/or user load U4 demand). In some implementations, energy management system 1630 can include a controller (e.g., a processor and a memory) configured to manage the distribution of electric power to the electric bus and/or from the electric bus based on load demand.

Energy forecasting and allocation system 1640 can be and/or include a compute device configured to estimate energy allowance (or demand) for user load U1, user load U2, user load U3, and/or user load U4 based on conditions of energy management system 1630 and/or based on parameters of active meter 1651, active meter 1652, active meter 1653, and/or active meter 1654 and configured to cause energy management system 1630 to distribute energy to user load U1, user load U2, user load U3, and/or user load U4 based on the estimated energy allowance(s). The compute device can include a processor and a memory that stores instructions that when executed by the processor can cause the processor to perform one or more functions described herein.

Active meter 1651 can be configured to measure power draw by user load U1. Active meter 1652 can be configured to measure power draw by user load U2. Active meter 1653 can be configured to measure power draw by user load U3. Active meter 1654 can be configured to measure power draw by user load U4. Each of user load U1, user load U2, user load U3, and user load U4 can represent different electrical loads such as, for example, appliances of a residential building, equipment of an industrial building such as a factory, compute resources of a commercial building such as an office, and/or the like.

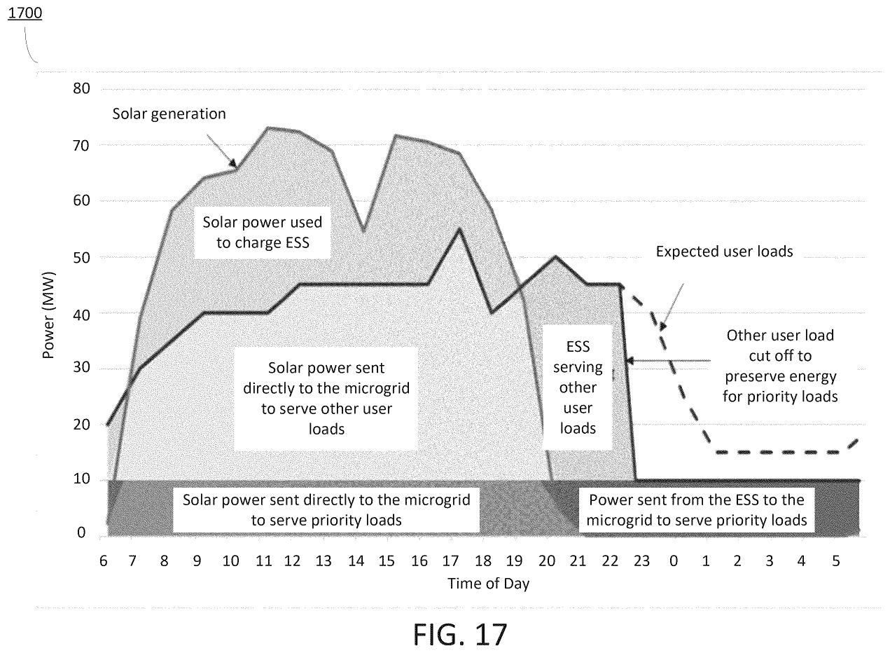

FIG. 17 is a graph 1700 depicting an example energy production forecast and allocation with prioritization, according to an embodiment. The graph 1700 shows example data including forecasted (or predicted) power data (in MW) as a function of the time of day. In some implementations, the forecasted power data can be estimated by an energy forecasting and allocation system, such as the energy forecasting and allocation system 1640 of FIG. 16. In some implementations, the forecasted power data can be based on past (or historical) measurements by an active meter such as the active meters of FIG. 16. The forecasted power data includes first data representative of solar power for charging an energy storage system (e.g., the energy storage system 1620 of FIG. 16), second data representative of solar power for sending directly to the microgrid (e.g., components of microgrid system 1600 other than solar arrays 1610 of FIG. 16), and third data representative of expected user loads.

As depicted, the first data at least partially overlaps with the second data between the hours of about 6:00 and about 20:00 where the first data (i.e. solar power for charging the ESS) has an average power greater than an average power of the second data. During such hours, solar power from solar arrays can be sent (e.g., caused to be sent by energy management system 1630 of FIG. 16 as determined by for example energy forecasting and allocation system 1640 of FIG. 16) directly to the microgrid system to serve priority loads while the ESS (e.g., the ESS 1620 of FIG. 16) can be at least partially restricted (e.g., caused to be restricted by energy management system 1630 of FIG. 16 as determined by for example energy forecasting and allocation system 1640 of FIG. 16) from releasing stored energy to serve priority loads. As depicted, between the hours of about 19:30 and about 23:00 (or whenever solar arrays stop receiving solar energy), the ESS (e.g., the ESS 1620 of FIG. 16) can be caused to release stored energy to serve user loads other than (or in addition to) prioritized user loads. As depicted, between the hours of about 23:00 and about 6:00, user loads other than prioritized user loads can be cut off (e.g., restricted from receiving stored energy from the ESS) to preserve energy for priority loads. An energy management system and/or energy forecasting and allocation system can determine a time to preserve energy for priority loads based on the third data representative of expected user loads, which shows that between such hours user loads are forecasted to drop significantly (to about 15 MW) compared to daytime averages (between 20-55 MW).

Additional implementation details (including physical hardware and software features) about systems and methods for a mobile micro utility, compatible with embodiments set forth herein, can be found, by way of example, in U.S. Pat. Nos. 11,764,577 and 11,824,357, the entire contents of each of which are incorporated by reference herein for all purposes.

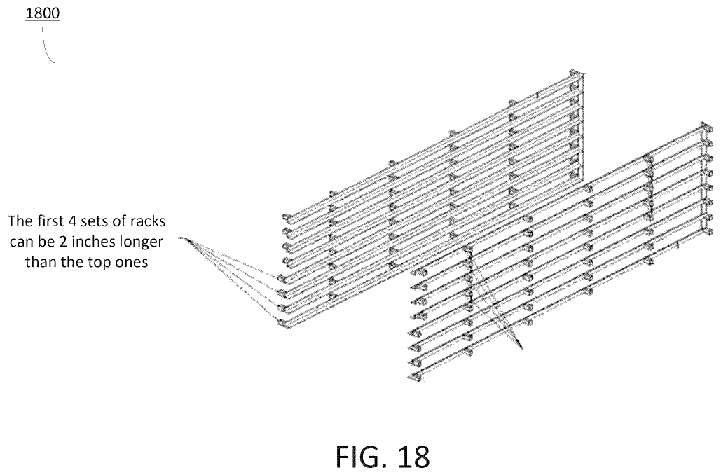

FIG. 18 shows an example hardware description for a transportable solar microutility system, in accordance with some embodiments. More specifically, FIG. 18 depicts a perspective view of a configuration for rails 1800 within a shipping container, according to an embodiment. The rails can be configured to mechanically support solar panel racks (e.g., solar panel racks 1420 of FIG. 14; not shown in FIG. 18) for example during storage and/or transport by the shipping container (e.g., the shipping container 1410 of FIG. 14; not shown in FIG. 18). In some implementations, a first set of racks nearer a floor of the interior of the shipping container can have spacing that is larger than spacing of a second set of racks nearer a ceiling of the interior of the shipping container. For example, a first set of racks nearer the floor can having spacing that is 2 inches larger than spacing of a second set of racks nearer the ceiling.

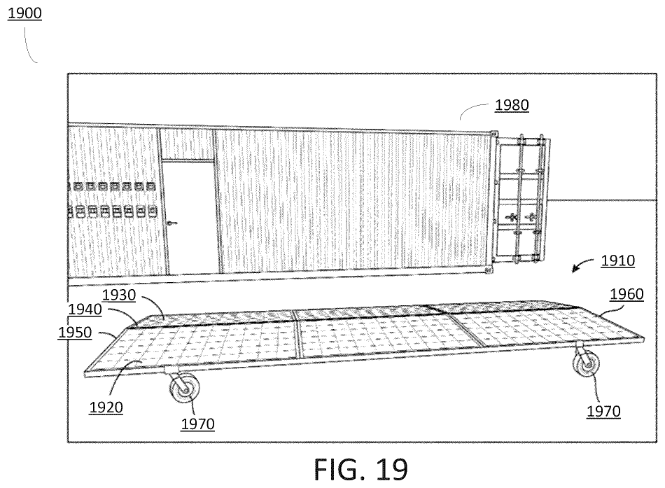

FIG. 19 depicts a perspective view of a solar panel rack 1910 of a solar array, according to an embodiment. The solar panel rack 1910 can be structurally and/or functionally similar to the solar panel racks of any of the embodiments described herein. Solar panel rack 1910 includes solar module row 1920 (e.g., structurally and/or functionally similar to solar module row 214 of FIG. 2), solar module row 1930 (e.g., structurally and/or functionally similar to solar module row 212 of FIG. 2), axis 1940 defined between (or formed by) solar module row 1920 and solar module row 1930, end portion 1950, end portion 1960 (opposite to end portion 1950), and wheels 1970. In some implementations, solar panel rack 1910 can be disposed within shipping container 1980 (e.g., structurally and/or functionally similar to shipping container 1410 of FIG. 14). In some implementations, solar panel rack 1910 can be coupled to one or more wind deflector(s) as described herein.

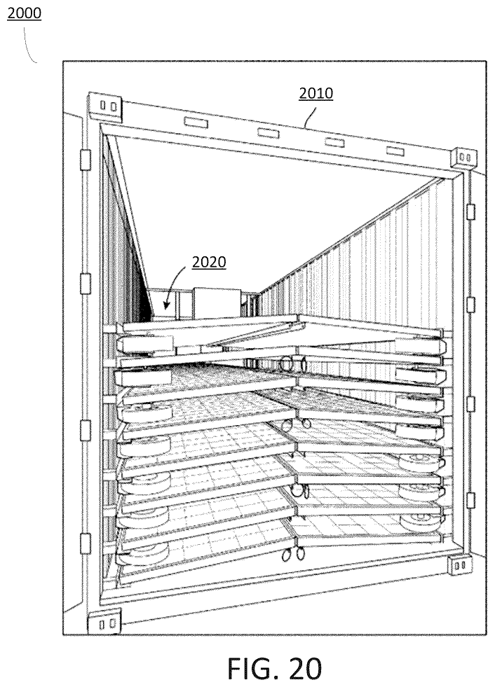

FIG. 20 depicts a perspective view of an example system 2000 for storing solar panel racks 2020 within a shipping container 2010, according to an embodiment. FIG. 20 shows an example of how the solar panel racks 2020 of a solar array can be stored on the rails inside the shipping container 2010, in accordance with some embodiments. The example system 2000 can be structurally and/or functionally similar to the example system 1400 of FIG. 14. In some implementations, solar panel racks 2020 can be coupled to one or more wind deflector(s) as described herein.

In some embodiments, an apparatus comprises: a wind deflector for a solar tent array including at least a first solar module and a second solar module, the first solar module and the second solar module each being positioned to form an apex of the solar tent array, the wind deflector at least one of: (i) including a gable end portion configured to reduce airflow through a first area defined at least in part by the apex of the solar tent array, the gable end portion of the wind deflector configured, during use, to be disposed between the apex of the solar tent array and a surface beneath a lower edge portion of the solar tent array, or (ii) including a side portion configured to reduce airflow through a second area defined in part by the lower edge portion of the solar tent array, the side portion of the wind deflector configured, during use, to be disposed between the lower edge portion of the solar tent array and the surface beneath the lower edge portion of the solar tent array, and a substantially rigid connector configured to mechanically couple the wind deflector to the solar tent array.

In some such implementations, the wind deflector includes the gable end portion; and the gable end portion is configured, when mechanically coupled to the solar tent array, to set a nonzero angle between the first solar module and the second solar module to a predefined value.

In some such implementations, the surface beneath the lower edge portion of the solar tent array is ground, and a surface-contact portion of the wind deflector is configured, during use, to distribute a weight of the solar tent array across the ground to reduce deformation of the ground by the solar tent array.

In some such implementations, the surface-contact portion of the wind deflector is a portion of at least one of the gable end portion or the side portion.

In some such implementations, the apparatus further comprises: a planar support configured, during use, to mechanically support the solar tent array a non-zero distance above the surface beneath the lower edge portion of the solar tent array when the planar support is in use, the planar support being mechanically coupled to at least one of the gable end portion of the wind deflector or the side portion of the wind deflector, the planar support having at least one air gap defined therein, the at least one air gap being sized and shaped to permit airflow therethrough to facilitate cooling of the solar tent array during use.

In some such implementations, the wind deflector includes an upturned portion configured to (a) be disposed above the lower edge portion of the solar tent array at a point along a length of the lower edge portion when the wind deflector is in use and (b) prevent lateral movement of at least one of the first solar module or the second solar module towards the surface beneath the lower edge portion of the solar tent array.

In some such implementations, at least one of: the gable end portion has a surface defining a first set of openings configured to permit a first predefined amount of airflow therethrough, or the side portion has a surface defining a second set of openings configured to permit a second predefined amount of airflow therethrough.

In some such implementations, the gable end portion has a raised edge configured to be disposed above the solar tent array when the gable end portion is in use, the raised edge configured to, with respect to the solar tent array, reduce airflow, reduce lift, and increase downforce.

In some such implementations, the gable end portion has a raised edge configured to be disposed above the solar tent array when the gable end portion is in use, and the gable end portion has a ledge configured to at least partially mechanically support a portion of the solar tent array, the portion of the solar tent array configured to be disposed between the raised edge and the ledge when the gable end portion is in use.

In some such implementations, during use, an air gap is defined between the gable end portion of the wind deflector and the solar tent array, the air gap sized and shaped to permit cooling air to circulate beneath the solar tent array.

In some such implementations, the surface beneath the lower edge portion of the solar tent array is substantially level, the wind deflector is configured, during use, to entirely block airflow through a space disposed between the solar tent array and the surface.

In some embodiments, an apparatus comprises: a wind deflector including a gable end portion having a first edge, a second edge, and a base that is configured, during use, to (1) contact at least one of (i) a lower edge portion of a frame of a first solar module or (ii) a lower edge portion of a frame of a second solar module, and (2) define an air gap to permit a specified amount of airflow therethrough; a first coupler configured to rigidly connect the first edge of the gable end portion to the frame of the first solar module; and a second coupler configured to rigidly connect the second edge of the gable end portion to the frame of the second solar module, the first solar module and the second solar module defining a solar tent array, the wind deflector configured, during use, to reduce aerodynamic lifting forces on the solar tent array.

In some such implementations, the air gap is disposed between the base of the gable end portion and an uneven surface, and the air gap is sized to at least one of (i) permit water drainage from a space disposed between the solar tent array and the uneven surface and to a surrounding environment, or (ii) facilitate positioning of the wind deflector above the uneven surface.

In some such implementations, the air gap is disposed between at least one of (a) the first edge of the gable end portion and the frame of the first solar module, or (b) the second edge of the gable end portion and the frame of the second solar module.

In some such implementations, the apparatus further comprises: a planar support configured to mechanically support the solar tent array a non-zero distance above a surface, the planar support being mechanically coupled to the wind deflector.

In some such implementations, the air gap is a first air gap, and the wind deflector further includes a standoff side portion configured, during use, to (i) deflect airflow from the lower edge portion of the frame of the first solar module over an active surface of the first solar module and (ii) define a second air gap disposed laterally between the standoff side portion and the lower edge portion of the frame of the first solar module, the standoff side portion configured to be rigidly connected to the lower edge portion of the frame of the first solar module at one or more points along a length of the standoff side portion.

In some such implementations, the apparatus further comprises: a planar support configured to mechanically support the first solar module a non-zero distance above a surface, the planar support including at least one air gap defined therein that is sized and shaped to permit airflow to pass therethrough, the wind deflector further including a standoff side portion configured, during use, to deflect airflow from the lower edge portion of the frame of the first solar module over an active surface of the first solar module, the standoff side portion being mechanically coupled to the planar support.

In some such implementations, the air gap is a first air gap, the apparatus further comprising: a planar support configured to mechanically support the first solar module a non-zero distance above a surface to define a second air gap between the first solar module and the surface, and a baffle configured to be disposed between a first side of the solar tent array and a second side of the solar tent array opposite to the first side, and configured to deflect wind that passes through the second air gap.

In some embodiments, a system comprises: a solar tent array including at least a first solar module and a second solar module; and a wind deflector including: a gable end portion configured, during use, to (i) set a nonzero angle between the first solar module and the second solar module to a predefined value to form an apex of the solar tent array, (ii) reduce airflow between a first portion of the solar tent array and a second portion of the solar tent array, the first portion being opposite to the second portion, the gable end portion of the wind deflector at least partially disposed between the apex of the solar tent array and a first lower edge portion of the solar tent array when the gable end portion is in use, and a side portion configured, during use, to reduce airflow between the first lower edge portion of the solar tent array and a second lower edge portion of the solar tent array, the first lower edge portion being opposite to the second lower edge portion.

In some such implementations, the side portion of the wind deflector defines a first air gap between an upper edge portion of the side portion and the first lower edge portion of the solar tent array when the side portion of the wind deflector is in use, and the apex of the solar tent array defines a second air gap disposed between the first solar module and the second solar module, the second air gap and the first air gap (a) causing cool air to enter, through the first air gap, into a space disposed between the solar tent array and a surface, and (b) causing warm air to exit, through the second air gap, from the space.

As used herein, the terms “substantially” and “about” each refer to an equivalence that accounts for minor variations from an absolute value or absolute state. In some instances, minor variations can be attributable to manufacturing tolerances or expected fluctuations in component performance or state. For example, a first angle that is substantially equal to(or is about) a second angle is understood to mean that the first angle is 99.9% equivalent, 99.5% equivalent, 99.2% equivalent, etc. to the second angle. As another example, a substantially polygonal shaped structure refers to a structure that appears as a multi-dimensional shape but permits minor geometric deviations, such that one or more defining dimensions (e.g., base, edge, radius, height, area, volume, etc.) can differ from those of an ideal shape by no more than a small tolerance (e.g., 0.25%, 0.5%, 1%, etc.). As yet another example, a substantially rigid connector can be a rigid connector that permits minor fluctuations or perturbations that temporarily affect rigidity by no more than a small amount (e.g., <1%, <0.5%, <0.25%, etc.).

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

While various embodiments have been described above, it should be understood that they have been presented by way of example only, and not limitation. While the embodiments have been particularly shown and described, it will be understood that various changes in form and details may be made. Where schematics and/or embodiments described above indicate certain components arranged in certain orientations or positions, the arrangement of components may be modified. Although various embodiments have been described as having particular features and/or combinations of components, other embodiments are possible having a combination of any features and/or components from any of embodiments as discussed above.

The disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An apparatus, comprising:
a wind deflector for a solar tent array including at least a first solar module and a second solar module, the first solar module and the second solar module each being positioned to form an apex of the solar tent array, the wind deflector at least one of:
(i) including a gable end portion configured to reduce airflow through a first area defined at least in part by the apex of the solar tent array, the gable end portion of the wind deflector configured, during use, to be disposed between the apex of the solar tent array and a surface beneath a lower edge portion of the solar tent array, or
(ii) including a side portion configured to reduce airflow through a second area defined in part by the lower edge portion of the solar tent array, the side portion of the wind deflector configured, during use, to be disposed between the lower edge portion of the solar tent array and the surface beneath the lower edge portion of the solar tent array, and
a substantially rigid connector configured to mechanically couple the wind deflector to the solar tent array.

2. The apparatus of claim 1, wherein:
the wind deflector includes the gable end portion; and
the gable end portion is configured, when mechanically coupled to the solar tent array, to set a nonzero angle between the first solar module and the second solar module to a predefined value.

3. The apparatus of claim 1, wherein:
the surface beneath the lower edge portion of the solar tent array is ground, and
a surface-contact portion of the wind deflector is configured, during use, to distribute a weight of the solar tent array across the ground to reduce deformation of the ground by the solar tent array.

4. The apparatus of claim 3, wherein the surface-contact portion of the wind deflector is a portion of at least one of the gable end portion or the side portion.

5. The apparatus of claim 1, further comprising:
a planar support configured, during use, to mechanically support the solar tent array a non-zero distance above the surface beneath the lower edge portion of the solar tent array when the planar support is in use, the planar support being mechanically coupled to at least one of the gable end portion of the wind deflector or the side portion of the wind deflector,
the planar support having at least one air gap defined therein, the at least one air gap being sized and shaped to permit airflow therethrough to facilitate cooling of the solar tent array during use.

6. The apparatus of claim 1, wherein:
the wind deflector includes an upturned portion configured to (a) be disposed above the lower edge portion of the solar tent array at a point along a length of the lower edge portion when the wind deflector is in use and (b) prevent lateral movement of at least one of the first solar module or the second solar module towards the surface beneath the lower edge portion of the solar tent array.

7. The apparatus of claim 1, wherein at least one of:
the gable end portion has a surface defining a first set of openings configured to permit a first predefined amount of airflow therethrough, or
the side portion has a surface defining a second set of openings configured to permit a second predefined amount of airflow therethrough.

8. The apparatus of claim 1, wherein the gable end portion has a raised edge configured to be disposed above the solar tent array when the gable end portion is in use, the raised edge configured to, with respect to the solar tent array, reduce airflow, reduce lift, and increase downforce.

9. The apparatus of claim 1, wherein:
the gable end portion has a raised edge configured to be disposed above the solar tent array when the gable end portion is in use, and
the gable end portion has a ledge configured to at least partially mechanically support a portion of the solar tent array, the portion of the solar tent array configured to be disposed between the raised edge and the ledge when the gable end portion is in use.

10. The apparatus of claim 1, wherein:
during use, an air gap is defined between at least one of:
the gable end portion of the wind deflector and the solar tent array, or
the side portion of the wind deflector and the solar tent array,
the air gap sized and shaped to permit cooling air to circulate beneath the solar tent array.

11. The apparatus of claim 1, wherein:
the surface beneath the lower edge portion of the solar tent array is substantially level,
the wind deflector is configured, during use, to entirely block airflow through a space disposed between the solar tent array and the surface.

12. An apparatus, comprising:
a wind deflector including a gable end portion having a first edge, a second edge, and a base that is configured, during use, to (1) contact at least one of (i) a lower edge portion of a frame of a first solar module or (ii) a lower edge portion of a frame of a second solar module, and (2) define an air gap to permit a specified amount of airflow therethrough;
a first coupler configured to rigidly connect the first edge of the gable end portion to the frame of the first solar module; and
a second coupler configured to rigidly connect the second edge of the gable end portion to the frame of the second solar module,
the first solar module and the second solar module defining a solar tent array, the wind deflector configured, during use, to reduce aerodynamic lifting forces on the solar tent array.

13. The apparatus of claim 12, wherein:
the air gap is disposed between the base of the gable end portion and an uneven surface, and
the air gap is sized to at least one of (i) permit water drainage from a space disposed between the solar tent array and the uneven surface and to a surrounding environment, or (ii) facilitate positioning of the wind deflector above the uneven surface.

14. The apparatus of claim 12, wherein the air gap is disposed between at least one of (a) the first edge of the gable end portion and the frame of the first solar module, or (b) the second edge of the gable end portion and the frame of the second solar module.

15. The apparatus of claim 12, further comprising:
a planar support configured to mechanically support the solar tent array a non-zero distance above a surface, the planar support being mechanically coupled to the wind deflector.

16. The apparatus of claim 12, wherein:
the air gap is a first air gap, and
the wind deflector further includes a standoff side portion configured, during use, to (i) deflect airflow from the lower edge portion of the frame of the first solar module over an active surface of the first solar module and (ii) define a second air gap disposed laterally between the standoff side portion and the lower edge portion of the frame of the first solar module, the standoff side portion configured to be rigidly connected to the lower edge portion of the frame of the first solar module at one or more points along a length of the standoff side portion.

17. The apparatus of claim 12, further comprising:
a planar support configured to mechanically support the first solar module a non-zero distance above a surface, the planar support including at least one air gap defined therein that is sized and shaped to permit airflow to pass therethrough,
the wind deflector further including a standoff side portion configured, during use, to deflect airflow from the lower edge portion of the frame of the first solar module over an active surface of the first solar module,
the standoff side portion being mechanically coupled to the planar support.

18. The apparatus of claim 12, wherein the air gap is a first air gap, the apparatus further comprising:
a planar support configured to mechanically support the first solar module a non-zero distance above a surface to define a second air gap between the first solar module and the surface, and
a baffle configured to be disposed between a first side of the solar tent array and a second side of the solar tent array opposite to the first side, and configured to deflect wind that passes through the second air gap.

19. A system, comprising:
a solar tent array including at least a first solar module and a second solar module; and
a wind deflector including:
a gable end portion configured, during use, to (i) set a nonzero angle between the first solar module and the second solar module to a predefined value to form an apex of the solar tent array, (ii) reduce airflow between a first portion of the solar tent array and a second portion of the solar tent array, the first portion being opposite to the second portion, the gable end portion of the wind deflector at least partially disposed between the apex of the solar tent array and a first lower edge portion of the solar tent array when the gable end portion is in use, and
a side portion configured, during use, to reduce airflow between the first lower edge portion of the solar tent array and a second lower edge portion of the solar tent array, the first lower edge portion being opposite to the second lower edge portion.

20. The system of claim 19, wherein:
the side portion of the wind deflector defines a first air gap between an upper edge portion of the side portion and the first lower edge portion of the solar tent array when the side portion of the wind deflector is in use, and
the apex of the solar tent array defines a second air gap disposed between the first solar module and the second solar module, the second air gap and the first air gap (a) causing cool air to enter, through the first air gap, into a space disposed between the solar tent array and a surface, and (b) causing warm air to exit, through the second air gap, from the space.
